(19) United States
(12) Patent Application Publication
(10) Pub. No.: US 2016/0275580 A1
(43) Pub. Date: Sep. 22, 2016

(54) COMPUTER-BASED SYSTEM FOR TRACKING AND OPTIMIZING PRODUCTIVITY OF AGRICULTURAL PRODUCTS

(71) Applicant: Edward Yoshio UECHI, Odenton, MD (US)

(72) Inventor: Edward Yoshio UECHI, Odenton, MD (US)

(21) Appl. No.: 14/820,541

(22) Filed: Aug. 6, 2015

Related U.S. Application Data
(60) Provisional application No. 62/134,620, filed on Mar. 18, 2015.

(51) Int. Cl. G06Q 30/06; G06Q 10/06; G06Q 10/08; G06Q 50/02

(52) U.S. Cl. CPC G06Q 30/0609; G06Q 50/02; G06Q 10/06315; G06Q 10/0838

(57) ABSTRACT

A data management system, method, and non-transitory storage device for tracking an agriculture product from origin to shipment to market, and for optimizing productivity of the agriculture product by analyzing the compiled data and modifying future activities accordingly. A single source data repository maintains records of agricultural, administrative, environmental, and process data related to the agriculture product in one-to-many and one-to-one relationships and utilizes at least one special purpose computer server that serves as a storage server for the compiled data and at least one special purpose computer server that serves as a Web server for handling, processing, and completing data requests and retrieval from a plurality of users.

This application claims the benefit of provisional application 62/134,620 filed Mar. 18, 2015, the entire content of which is expressly incorporated herein by reference thereto.

### BACKGROUND OF THE INVENTION

1. Technical Field

The present invention relates to an innovative computer software system and method for tracking and optimizing productivity of agricultural products, such as food products including crops, livestock, and fish-stock, as well as additional staples such as tobacco and cotton, which are converted into consumer products. The products also include animal feed products such as grass or hay. The present disclosure relates generally to a system for data management for such products which has heretofore not been realized by the agricultural, farming, and fishing communities. More particularly, the present disclosure relates to a system for managing agricultural data in the agriculture industry. Still more particularly, the present disclosure relates to a method of tracing and tracking a crop variety, farm animal, or other agricultural product across the agricultural production cycle, as well as a method of optimizing future farm productivity and/or quality.

2. Description of the Related Art

Many farms continue to document their records on paper and store their records in binders and notebooks. A critical issue with paper records is the significant reduction in precision. Numerous activities occur on a daily basis across many acres of land. Over several seasons, cycles, and years, the total amount of records can multiply exponentially. As a tradeoff to recording activities for every acre or plot, data aggregation is applied by grouping acres or plots and calculating averages. The result of this method could, for example, lead to applying too much fertilizer in one plot that may not need it and applying not enough fertilizer in a neighboring plot. From a business perspective, resources could be used ineffectively or wasted. There is a need for a system to record farming activities with a high degree of precision.

Computer systems in the agriculture industry focus on making farm equipment very precise in collecting data. Computers, sensors, and other electronic hardware are integrated into the mechanics of a tractor, a boom sprayer, a harvester, and other farm equipment. One problem with such computerized farm equipment is that each piece of equipment is separate from one another. Further, a farm does not need just a harvester. Each piece of equipment collects specific data for a specific purpose. If the equipment is not connected to a computer network, stored data will remain inside the equipment and excluded from enterprise-wide data analysis. Even if the equipment is connected, exported data from one equipment could be difficult to merge with the records of other equipment. Additionally, equipment manufacturers may implement different data formats. Thus, there exists a need for a central data management system that can retrieve and merge disparate data sets from several sources.

U.S. Pat. Nos. 8,924,030 B2 and 7,761,334 B2 are examples of computerized farm equipment.

U.S. Pat. Nos. 7,761,334 B2 and 7,756,719 B2 provide a system and a method for transferring data records from farm equipment to a data management system. In order for the system to work, however, a specialized data processing system is required to be a component of or attached to the farm equipment. Some farmers who operate small farms or reside in developing and emerging countries may not have the resources to procure specialized farm equipment, and would depend on basic equipment. Since the patents rely on specialized equipment, the approach to transferring data records to a data management system could be problematic. It is apparent in U.S. Pat. No. 7,756,719 B2 that combining records from several stages is carried out through intermediary databases before being sent to the final database. New data is appended at each stage to form a composite (a larger data set) that then gets sent to the data management system. This linear approach creates multiple points of potential failure.

U.S. Pat. No. 8,479,221 B2 provides a method of transferring data records automatically from farm equipment and external sources based on configured events. The software program performs as a pass-through system where incoming data is processed in a pre-determined format and sent to a receiving party that can be either an internal unit or an external organization. Data records focus on farming operations collected at the field, geo-position data, and environmental data. This patent relies completely on automation. Automation assumes that program instructions are configured in a particular way to which all the components including input data must conform. No provision is made, however, for handling occurrences that will happen when a peculiar need arises that does not fit the configuration or that stops the automated process.

Many organizations are involved in agricultural production. The farm is the principal organization that manages the growth of farm products from origin through harvesting. Once the farm product has reached maturity, the edible or usable parts are either packaged and shipped directly to market for immediate consumption, or sent to a processor to be converted into a new, processed farm product that is then packaged and shipped to market. The fresh or processed farm product is packaged for transport over land, rail, or sea by a transportation company. An intermediary organization, such as a distributor, facilitates this process of delivering the farm product. Many additional organizations are also involved in the farm product's cycle from origin to market for final sale before consumption. For instance, various suppliers produce and sell seeds, chemicals, and other resources for farms and processors. Private and non-profit organizations provide insurance and education to protect investments in farm products and to improve overall capacity. A government agency requires reports and documentation to enforce laws and regulations related to the environment. These organizations have needs to either request data from the farm or provide data to the farm. Thus, there exists a need for a system that not only stores essential data relating to activities on the farm, but also one that is more inclusive, wherein data is both collected from, and retrieved by, diverse organizations.

This finally comes to the subject of food traceability. In today's economy, most people do not grow their own food and instead purchase food from retail outlets. The retail outlet such as a grocery store or a farmers' market is at the end of the chain in the agricultural production cycle. As such, the consumer would not be aware of how the food product sitting on the shelf was produced or the amount of time and labor that went to its growth and production. Increasingly, health-conscious consumers would like to know how the food was made. What is more, gathering as much information regarding a food product becomes critical in the event of a public health crisis. If people have fallen ill due to food contamination, the authorities in cooperation with producers and other organizations will need to identify all the factors that led to such a situation. And since food is perishable, collecting all available information must be completed in a prompt and timely manner. Finding the root cause becomes increasingly difficult with the passage of time.

U.S. Pat. No. 7,412,461 B2 provides a system and a method for identifying and monitoring food contamination events and for analyzing the effectiveness of intervention strategies to contain the spread of disease or illness. It uses multiple databases related to distribution, consumption, disease, and public health. Data records come from relevant outside sources. In effect, the patent's databases are secondary sources. This patent only focuses on food distribution beginning at the harvest stage.

U.S. Pat. No. 8,833,654 B1 provides a method for a consumer to find the farm origin and harvest data associated with a food product at the retail outlet. A consumer may submit their opinion, preference, and other consumer-driven data that are related to the selected food product. Quality assessments may be conducted during the time when a food product sits on the shelf. Data records related to this patent relate to the shelf life of a food product at the end of the production cycle. Production data is limited to farm origin and harvest data.

U.S. Pat. No. 8,887,990 B2, which builds on U.S. Pat. Nos. 8,428,773 B1, 8,196,827 B1, and 7,766,240 B1, provides a system and a method to trace harvested and packed food product through distribution and back to the farm origin. It has a particular focus on labeling the food package. This patent collects information in the middle of the production cycle, specifically at the harvest and packing stages. With regard to food traceability, this patent has limited scope in which farm origin and harvest data can be found. This is because an investigator or a regulator would only find the source or place but not the cause of food contamination.

True food traceability requires a wide range of data records that span the entire agricultural production cycle. Thus, there needs to be improved systems and methods that are comprehensive in breadth and depth. Furthermore, those systems and methods should be able to identify factors in operations that result in food contamination or a disease outbreak and then such knowledge would allow the agricultural producer to modify their operations accordingly.

### SUMMARY OF THE INVENTION

The present invention is directed to a computer-based system for tracking and optimizing farm productivity. In one embodiment, the computer-based system processes information related to origin, production, processing, and distribution of an agricultural product. To do this, the system comprises one or more computers and connected electronic storage that stores computer-executable instructions and data that is used by the computer-executable instructions, wherein the one or more computers, computer-executable instructions, and data, together, configure the computer system to collect information by way of network connections, and process the information to provide tracking information of an agricultural product origin, production, processing and distribution as well as to provide agricultural product information to assist in optimizing agricultural product production or quality.

In particular, the one or more computers configured for collecting various agricultural, administrative, and environmental data; compiling the data in a database to establish how the agricultural product originated and was produced from its point of origin to a final destination for sale; and providing a report summarizing the compiled data to authenticate all activities related to the agricultural product's production, processing, and distribution.

The compiled agricultural data typically comprises combinations of various types of information related to the agricultural product, including data records that document activities relating to preparing the land, livestock, or fish-stock for the agricultural product's growth; data records that document activities related to attending to the agricultural product through the agricultural product's growth from its origin up to harvesting; data records that document crop, animal, or fish product varieties differentiated by type, family, and bioengineering, which are variations selected and used for production; data records that document water consumption by the agricultural product; and/or data records that document the quality of the agricultural product from monitoring the agricultural product throughout growth.

The compiled administrative data typically comprises combinations of various types of information related to the agricultural product, including equipment asset (e.g., a tractor) or stock supply (e.g., chemicals or fertilizer) data records that document usage; vendor data records differentiated by individual, vendor, corporate or institutional contributions during production; accounting data records that document purchase and sales orders; employee data records; and geographical location data records.

The compiled environmental data typically comprises combinations of various types of information related to the agricultural product, including water sampling data records that evaluate water quality; soil sampling data records that evaluate soil quality; plant monitoring data records that document status, growth, and health of cultivated plants; pest data records that document risks to plant cultivation; and weather monitoring data records that document temperature, barometric pressure, precipitation, and related weather data.

In another embodiment, the one or more computers are advantageously configured for compiling process data in the database to authenticate all activities related to processing, packaging, and shipping the agricultural product. Thus, the compiled process data comprises combinations of various types of information related to the agricultural product, including data records that document preparing the agricultural product for packaging once it arrives at a packing facility and packaging the agricultural product for shipment to market, or alternatively, data records that document converting the agricultural product into a new product, and then packaging the converted agricultural product for shipment to market; and data records that document shipping information including the agricultural product's point of origin, final destination for sale, estimated time of departure and arrival, and transportation identification including shipping container or shipping pallet identification.

Preferably, the one or more computers are further configured for assigning a unique identifier to the agricultural product; compiling daily farming activities for the agricultural product, and associating the compiled activities to the agricultural product via the unique identifier; processing the agricultural product for shipment; compiling processing activities related to the processing of the agricultural product, and associating the compiled activities to the agricultural product via the unique identifier; shipping the agricultural product; compiling shipping information of the agricultural product, and associating the shipping information to the agricultural product via the unique identifier; and providing a listing of the compiled information on the shipped agricultural product to confirm for consumers the creation, processing, and tracking of the agricultural product from its origin to final point of sale. This authenticates the origin and all processing of the agricultural product from inception to user consumption.

The one or more computers include a logical data model that relates data from a plurality of subjects in one-to-many or one-to-one relationships; and wherein at least one special purpose computer server is designed to serve as a storage server for storing data records in accordance with the design of the logical data model; and a Web server for handling, processing, and completing requests from a plurality of users.

The computer-based system may also include an advanced computer network switch with load balancer functionality to manage and redirect connections from multiple users to the logical data model; a computer program product for human users to send and retrieve data records through an interface between the logical data model and a user's computer; a computer program product for machine users to transmit and process data records through an automated scripted procedure between the logical data model and an external, third party computer; and an Internet connection to allow the transmission of data records from the user computer to the logical data model.

Another embodiment of the present invention is directed to a computer-based method for process information related to origin, production, processing, and distribution of an agricultural product, wherein each step is conducted by one or more computers. This method generally comprises collecting various agricultural, administrative, and environmental data; compiling the data in a database to establish how the agricultural product originated and was produced from its point of origin to a final destination for sale; and providing processed tracking information in a report summarizing the compiled data to authenticate all activities related to the agricultural product's production, processing, and distribution.

This method preferably uses each of the compiled agricultural data, the compiled administrative data, the compiled environmental data disclosed herein, and the compiled process data in the database to authenticate all activities related to processing, packaging, and shipping the agricultural product. Also, it is preferred to have a unique identifier applied to the agricultural product to assist in compiling the data and providing a listing of the compiled information on the shipped agricultural product to confirm for consumers the creation, processing, and tracking of the agricultural product from its origin to final point of sale.

Another computer-based method is provided for optimizing productivity of agricultural products based on an analysis of operational data relating to the agricultural product, wherein each step is conducted by one or more computers. This method generally comprises collecting various agricultural, administrative, and environmental data; compiling the data in a database to establish how the agricultural product originated and was produced from its point of origin to a final destination for sale; and analyzing the data to determine modifications that can be used to optimize future production of the agricultural product. The modifications that are determined can then be applied so that future production of the agricultural product is optimized. This method preferably uses each of the compiled agricultural data, the compiled administrative data and the compiled environmental data disclosed herein.

These methods apply to all agricultural products and especially to those that are crops, animals, or fish. While the invention is optimal for crops and crop-based agricultural products, the user-configurable system design is adaptable for other agricultural products. A user may define their own agricultural product that may be based on land or in water. A defined farm plot may be the acreage of land that is intended for crop production or livestock management. Another defined farm plot may be the covered area of an artificial or natural body of water that is clearly demarcated and intended for fish-stock or other seafood.

Another aspect of the invention is a non-transitory processor readable medium for carrying out the computer-based methods disclosed herein and comprising processor readable instructions that when executed by the computer processor cause the computer processor to perform the method.

The invention specifically relates to a system for managing a wide range of data associated with agricultural production, the system comprising a logical data model that relates data from a plurality of subjects in one-to-many or one-to-one relationships; at least one special purpose computer server designed as a database server for operating the logical data model as a physical data model and for processing a plurality of data records in accordance with the design of the logical data model; at least one special purpose computer server designed as a storage server for storing a plurality of data records in accordance with the design of the logical data model; at least one special purpose computer server designed as a Web server for handling, processing, and completing requests from a plurality of users; an advanced computer network switch with load balancer functionality to manage and redirect connections from a plurality of users to the data model; a computer program product for human users to send and retrieve data records through a graphical user interface between the data model and a user's computer; a computer program product for machine users to transmit and process data records through an automated scripted procedure between the data model and an external, third party computer; and an Internet connection to allow the transmission of data records from a user computer to the data model.

In this system, the logical data model includes combinations of two or more or even all the following: a plurality of farm plot data records that document the amount of land used for farming; a plurality of crop variety data records differentiated by type, family, and bioengineering that are selected and used for production; a plurality of water usage data records that document the activity of watering crop varieties from specific water sources on designated farm plots; a plurality of crop protection data records that document the activity of spreading chemicals on designated farm plots; a plurality of crop harvest data records that document the activity of picking matured crop varieties on designated farm plots; a plurality of crop monitoring data records that document the activity of evaluating food quality; a plurality of food packing data records that document the activity of preparing and packaging received food for shipment; a plurality of food processing data records that document the activity of preparing, processing, and completing supplied food for processing; a plurality of food shipment data records that document the activity of transporting packaged food to distribution channels and market venues; a plurality of long-term held equipment asset data records that document usage as part of inventory management; a plurality of short-term held disposable stock supply data records that document usage as part of inventory management; a plurality of vendor data records differentiated by type that are involved in any stage of production; a plurality of accounting data records that document purchase and sales orders as part of financial management; a plurality of employee data records that are hired to do specified work as part of human resources; a plurality of incorporated, unincorporated, and informal jurisdiction geographical location data records that are structured in a hierarchy; a plurality of water sampling data records that document the activity of evaluating water quality; a plurality of soil sampling data records that document the activity of evaluating soil quality; a plurality of plant monitoring data records that document at-time readings and periodic observations of status, growth, and health of cultivated plants; a plurality of pest data records that are documented of posing risks to or having been observed of damaging cultivated plants; a plurality of weather monitoring data records that document at-time readings and periodic observations of temperature, barometric pressure, precipitation, and other weather related data. The system includes a plurality of data relationships that associate these data records in one-to-many or one-to-one relationships.

The system may also include a plurality of computer-based forms to read, add, edit, and delete data records; a plurality of computer-generated report files that lay out data records in printable form and for saving to a computer readable medium; a plurality of computer-generated charts that display statistical analysis of data records; a procedure that formats stored data records in a text file for exporting and saving to a computer readable medium; a mechanism for instantly switching the currently displayed interface language to a different interface language for a user who speaks the changed language; and a mechanism for restricting access to data records to registered users.

The system may also include a computer-generated or manually-prepared text file that contains a plurality of data records; an automated scripted procedure that reads, validates, and processes data records stored in the text file; and a mechanism for restricting access to execute the procedure to two computers that are exclusively involved in the operation.

Another embodiment of the invention relates to a method of tracing and tracking a crop variety across the agricultural production cycle. This method comprises a first step of assigning a unique identifier to a farm plot that is designated to grow a specified crop variety; a second step of binding daily farming activities to the unique identifier; a third step of binding crop harvest activities to the unique identifier; a fourth step of binding received food records, which had been delivered to a facility and checked in as received, to the unique identifier; a fifth step of maintaining the unique identifier as a link to a group of received food item records that are sampled for evaluation; a sixth step of binding packed food boxes to the unique identifier; a seventh step of maintaining the unique identifier as a link to a shipping pallet that is used to bundle the packed food boxes; and an eighth step of binding shipping pallet records to a freight shipment in general or an intermodal shipping container in particular for transportation.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows the range of data records that are collected and associated, and highlights a single unique identifier (FARM PLOT NO.) that is used to trace and track an agricultural product across the agricultural production cycle.

FIG. 2 shows, from the perspective of the present invention, a high-level workflow process of the agricultural production cycle.

FIG. 3 shows the elements that are programmed in three computer software programs and a relational database management system.

FIG. 4, which is similar to FIG. 3, shows the integration of a relational database within a computer software program in a single product that executes on a desktop or laptop, personal computer.

FIG. 5 shows, in a preferred embodiment, an environment where various Internet-connected devices access a computer system that hosts a Web application computer program and a relational database management system.

FIG. 6 shows an example of a user interface of a Web application computer program.

FIG. 7 shows an example of a user interface of a PC-based application computer program.

FIG. 8 shows an example of a data entry form in general and a new farm plot record form in particular.

FIG. 9 shows an example of a record list page in general and a farm plot record list in particular, and highlights one farm plot record to show a method of tracing and tracking an agricultural product across the agricultural production cycle.

FIG. 10 shows an example of water usage records that are associated with the highlighted farm plot, and provides another example of a record list page in general.

FIG. 11 shows an example of crop protection records that are associated with the highlighted farm plot, and provides another example of a record list page in general.

FIG. 12 shows an example of crop harvest records that are associated with the highlighted farm plot, and provides another example of a record list page in general.

FIG. 13 shows an example of received food records that are associated with the highlighted farm plot and that are checked in at a packing facility.

FIG. 14 shows an example of received food records that are associated with the highlighted farm plot and that are available for sampling. The highlighted received food record is a reference for FIGS. 15 and 16.

FIG. 15 shows the details of one received food record, which had been accessed from FIG. 14.

FIG. 16 provides another example of a record list page in general, and in particular shows an example of sampled food item records that are associated with one received food record that in turn is associated with the highlighted farm plot.

FIG. 17 shows an example of boxed food records that are associated with the highlighted farm plot, and provides another example of a record list page in general. The highlighted BOX BAR CODE record is a reference for FIG. 19.

FIG. 18 shows an example of shipping container records in preparation for shipment. The highlighted container record is a reference for FIG. 19.

FIG. 19 shows an example of a data report in general and a partial page of the shipping container packing list report in particular, listing all associated boxed food records organized by shipping pallet. The referenced BOX BAR CODE shows the specific farm plot where the contents came from.

FIG. 20 shows a portion of a logical data model, focusing on post-harvest and shipment to show relationships between the boxed agricultural product, farm plot, and shipping container.

FIG. 21 shows a portion of a logical data model, focusing on farming and post-harvest to show relationships between farm plot, water usage, crop protection, crop harvest, received food, and crop sampling.

FIG. 22 shows a portion of a logical data model, focusing on geographical location to show a hierarchical structure of relationships between country, province/state, district/county, city, township/town, village, and cottage.

FIG. 23 shows a portion of a physical data model related to land preparation, and shows an example of data fields with specified machine readable names, data types, and other attributes.

FIG. 24 shows a system process flowchart for agricultural data entry operations in a standardized way for all data entry forms.

### DETAILED DESCRIPTION OF THE INVENTION

It is advantageous to define several terms that are used when describing the invention. It should be appreciated that the following definitions are used throughout this application to highlight the purposes of the present invention.

The term “agricultural product” refers to any edible or inedible plant-based, crop or crop-based products, livestock or livestock-based products, and fish-stock or fish-stock based products. This term includes the term “agriculture” which refers to any branch in the science of agriculture that includes, but is not limited to, animal husbandry, aquaculture, arboriculture, horticulture, silviculture, and viticulture, wherein each branch cultivates a particular product for human consumption, economic use, or beneficial care.

The term “crop” as used in defining a sub-group of the present invention's agriculture products, includes crops for consumption such as fruits, vegetables, grains, sugar cane, rice, and oilseeds; crops for clothing such as cotton; and other crops such as tobacco. It also includes grass, switchgrass or hay as animal feed. This list of crop types is not exhaustive, and thus, the present invention may apply to other versions of crops intended for consumption, clothing, or other uses not listed herein.

The term “processed agriculture product” refers to any previously defined agriculture product after it is converted into a new product prior to packaging for shipment to market for final sale.

The term “processed tracking information” refers to any data relating to preparing the agriculture product for packaging, the packaging process, shipping, and/or converting the agriculture product into a processed agriculture product prior to packaging for shipment to market.

The term “pest” refers to any species in the animal kingdom that poses a risk to or damages agriculture product.

The term “vendor” refers to any person, organization or institution that contributes to or is involved in any stage in production, processing, and/or distribution.

The term “agricultural data” refers to data records that document: activities relating to preparing the land, livestock, or fish-stock for the agriculture product's growth; activities related to attending to the agriculture product through the agriculture product's growth from origin up to harvesting; crop, animal, or fish product varieties differentiated by type, family, and bioengineering, which are variations selected and used for production; water consumption by the agriculture product; and/or the quality of the agriculture product from monitoring the agriculture product throughout growth.

The term “administrative data” refers to: equipment asset or stock supply data records that document usage; vendor data records differentiated by vendor contributions during production; accounting data records that document purchase and sales orders; employee data records; and/or geographical location data records. An equipment asset would generally be a multiple use item typically a mechanical device such as a tractor, while stock supply would be considered to be a single use item which typically would be fertilizer, pesticides, or other chemicals.

The term “environmental data” refers to: water sampling data records to evaluate water quality; soil sampling data records to evaluate soil quality; plant monitoring data records to track status, growth, and health of cultivated plants; pest data records that document risks to plant cultivation; and/or weather monitoring data records to monitor temperature, barometric pressure, precipitation, and related weather data.

The present invention is a data management system with a method of tracing and tracking an agriculture product across the agricultural production cycle from origin to finally shipping to market, as well as a method for optimizing future productivity of the agriculture products. By providing a tracing and tracking mechanism, the present invention allows farmers and fishermen to authenticate to consumers all activities related to the agriculture product throughout its production cycle. Such activities include, but are not limited to, farming, harvesting, processing, packaging, and shipment. Additionally, farmers and fishermen can analyze the collected data to make future modifications and in turn, optimize future production.

Accordingly, the present invention is a single source data repository that maintains numerous records related to agriculture, administration, and the environment in one-to-many and one-to-one relationships. Furthermore, the present invention is a Web application computer program that allows a human user to access a data management system to perform data entry and data retrieval operations and to process individual data records. Still furthermore, the present invention is a Web service application computer program that allows a machine user to process multiple data records in single transactions between a data management system and an external computer server or computerized farm equipment.

A tracing and tracking method, as well as an optimization method, are described with sample data presented in a series of views from a Web application computer program and portions of a logical data model. The primary embodiment describes the elements that are programmed in a Web application computer program and a relational database management system to allow a user's computer to access a remote computer system that hosts the Web application and relational database in a computer network.

As it will be appreciated by one skilled in the art, the present invention may include different embodiments in different forms. Technical details related to computer networking, computer hardware, or computer software may change for particular operating environments, as specific products are updated to resolve software bugs/issues, upgraded with faster components, or replaced entirely with new models/versions. The aspects of the present invention that do not change are those related to business and functional requirements. It will be understood in the description herein that the present invention is an exemplification of principles outlined in the business and functional requirements and is not intended to be limited by the details of the configuration of the computer system and the current version of the computer program set forth in the disclosed drawings. It will be further understood that each block and combination of blocks in the block diagrams, each step and combination of steps in the system flowchart, and each user interactive element and combination of elements depicted in the user interface can be implemented by computer program instructions.

Computer program code for carrying out operations of the present invention may be written in any one or combination of several object-oriented, procedural, and/or interpretative programming languages, including but not limited to C++, C#, Objective-C, Java, PHP, JSP, ASP, Cold Fusion, JavaScript, XML, CSS, HTML, T-SQL, and PL/SQL. Computer program code defines sets of program instructions that constitute a single computer program product. The computer program product may be installed prior to running, or immediately run without installation on a user's computer in which the program instructions are executed entirely on the user's computer; on a remote computer in which program instructions are executed entirely on the remote computer; or on both a user's computer and a remote computer in which program instructions are executed partially on the remote computer, and partially on the user's computer.

A computer may be a general purpose computer workstation/server, a special purpose computer workstation/server, or a hand-held computer device, any one of which contains a microprocessor unit, a random access memory (RAM) module or cache memory, a storage medium such as a hard disk drive (HDD), a network adapter/interface, an input-output (JO) interface, and one or more ports for peripheral devices (if applicable) for keyboard, pointing device, display, and/or programmable computer readable medium such as a flash drive. A computer network may not exist in the case of a stand-alone computer program product, may exist in a local area network (LAN) where several user computers are connected to one or more remote computers that all operate within a single physical building or within a cluster of physical buildings in close proximity, or may exist in a wide area network (WAN) where several user computers are connected to one or more remote computers that are separated by several miles and/or geographically located across a city, a region, a continent, or the world. A WAN may include a connection through the Internet using an Internet Service Provider (ISP).

The present invention would preferably utilize, if not be fully executed by, modern computing technology. The computer technology is user-interactive and may be self-contained so that users need not leave or venture to another address within a distributed computing network to access or provide the various information required by the systems and methods of the invention. The following discussion describes the structure of such an environment, such as the Internet or many common intranets.

The computing environment includes one or more servers which communicate with a distributed computer network via communication channels, whether wired or wireless, as is well-known to those of ordinary skill in the pertinent art. The server hosts multiple Web sites and houses multiple databases necessary for the proper operation of the subject technology. The host provider is capable of managing many sites and databases for many farms.

The server is any of a number of servers known to those skilled in the art that is intended to be operably connected to a network so as to operably link to a plurality of client computers via the distributed computer network. The plurality of client computers can be desktop computers, laptop computers, personal digital assistants, cellular telephones, and the like. The client computers allow users, contributors, or providers who gather or collect data to provide such information into one principal database, or if desired, multiple databases, which is/are necessary for conducting the methods of the invention. Additionally, these computers also process the information and allow the users to run applications on the server and locally as well as to print interim or final reports. The server and clients have displays, input devices, and output devices as would be appreciated by those of ordinary skill in the pertinent art.

In particular, in the present invention, the computer system that can be implemented is structured to carry out the foregoing functionalities and provide related interactive features and tools. A computer implemented system can be directed toward managing the one or more database and tracking the agriculture product as it is developed. It also initially establishes a unique identifier and then can associate the data with the agriculture product using the unique identifier. The system comprises one or more computers and connected electronic storage that stores computer-executable instructions and data that is used by the computer-executable instructions, wherein the one or more computers, the computer-executable instructions, and data, together, configure the computer system to provide an application that processes the data structure for the tracking of the agriculture product to authenticate and verify its development from origin through the various processing, packaging, and shipping stages so that the consumer knows exactly a complete history of the agriculture product. Also, various users are in communication by way of network connections with end devices so that additional data can be quickly and accurately added to the database.

And the invention includes a computer-readable storage medium such as a non-transitory computer readable medium that can comprise instructions executed by a processor or electronic device to perform at least some and preferably all of the steps of the methods and systems described herein.

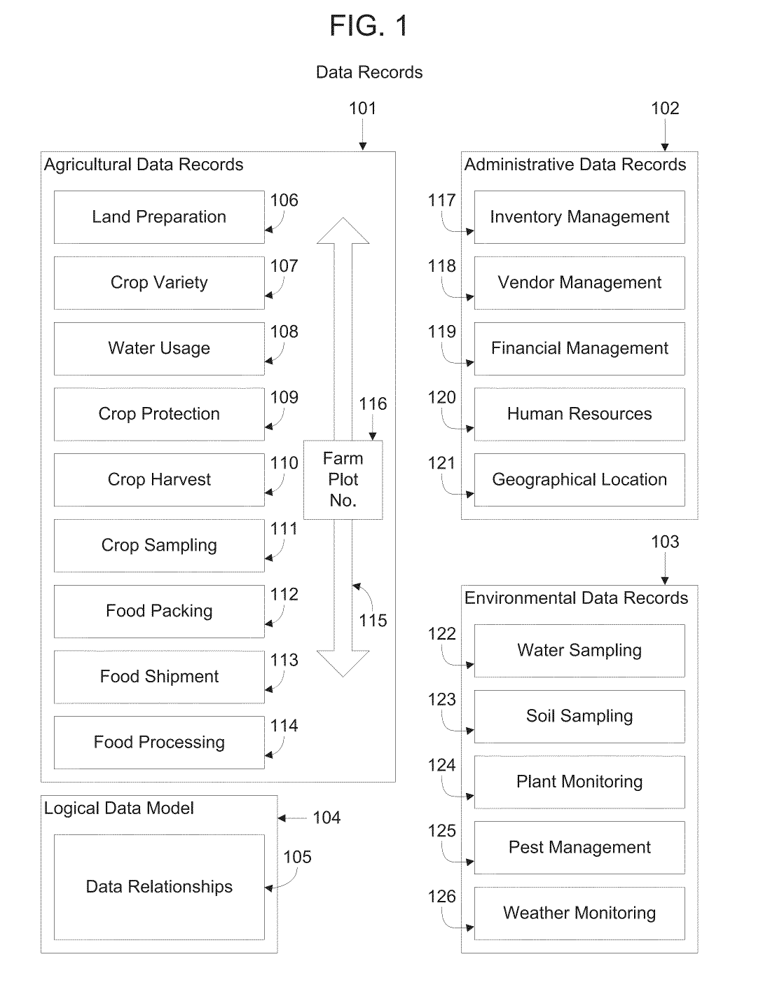

With reference to the figures, FIG. 1 is a business requirement that outlines data records that need to be collected and associated for an agriculture product such as a crop. Of course, the preferred embodiment of a crop as the agriculture product is exemplary only and the invention also applies the same technology for other agriculture products such as livestock or fish-stock. Specific subjects are organized under three general categories: agricultural data 101, administrative data 102, and environmental data 103. Under environmental data 103, specific subjects are water sampling 122, soil sampling 123, plant monitoring 124, pest management 125, and weather monitoring 126. Under administrative data 102, specific subjects are inventory management 117, vendor management 118, financial management 119, human resources 120, and geographical location 121. Under agricultural data 101, specific subjects are land preparation 106, crop variety 107, water usage 108, crop protection 109, crop harvest 110, crop sampling 111, food packing 112, food shipment 113, and food processing 114. Note that under agricultural data 101, “crop” is interchangeable with “animal” or “fish” products as an alternative agriculture product under the present invention.

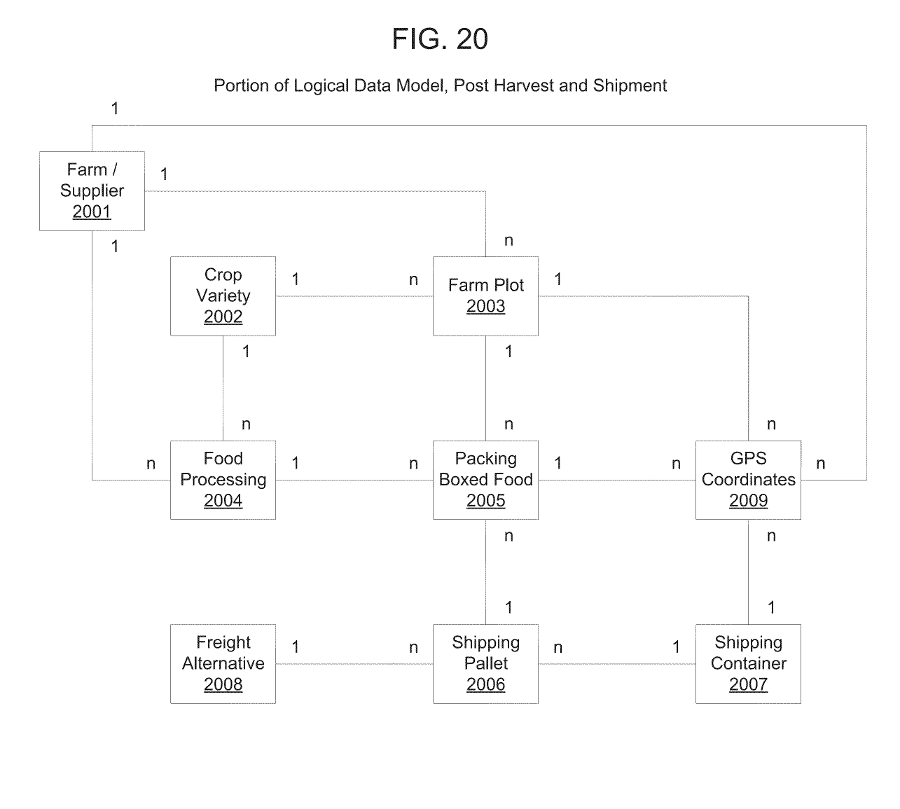

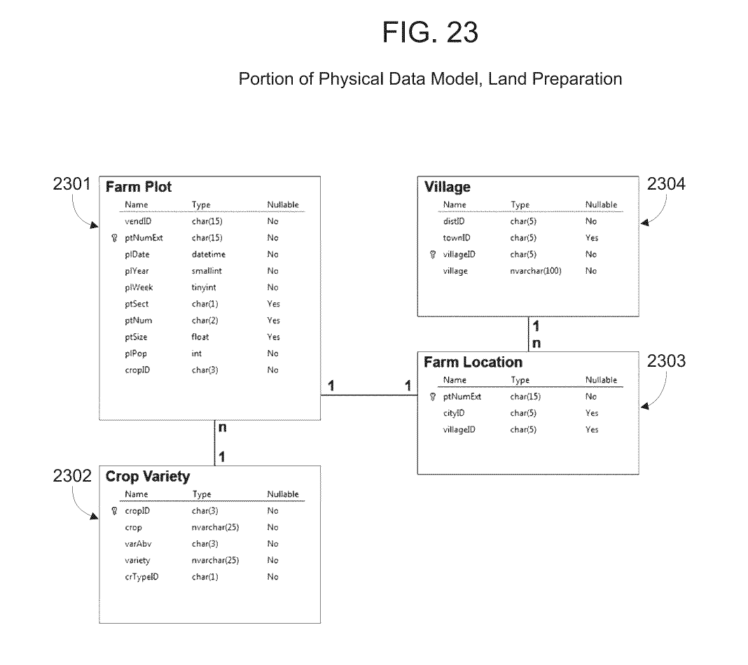

Each specific subject is a group of one or more data tables. Each data table contains one or more rows or records. Each record contains one or more data columns or fields. Each data field is a precise piece of information that holds a particular value. A logical data model 104 shows data relationships 105 between data tables, and is a block diagram for implementing data tables and data relationships in a relational database management system. Examples of a logical data model are shown in FIGS. 20, 21, and 22. In comparison, an example of an implemented model (physical data model) is shown in FIG. 23. A data relationship between any two data tables may be one-to-many or one-to-one. In one-to-many, for example, one record in Table A can be related to many records in Table B. In one-to-one, for example, one record in Table A can be related to only one record in Table B, which extends the unique record from Table A to Table B. Data relationships are logically drawn based on business requirements, and are made between data tables within a category and data tables across categories.

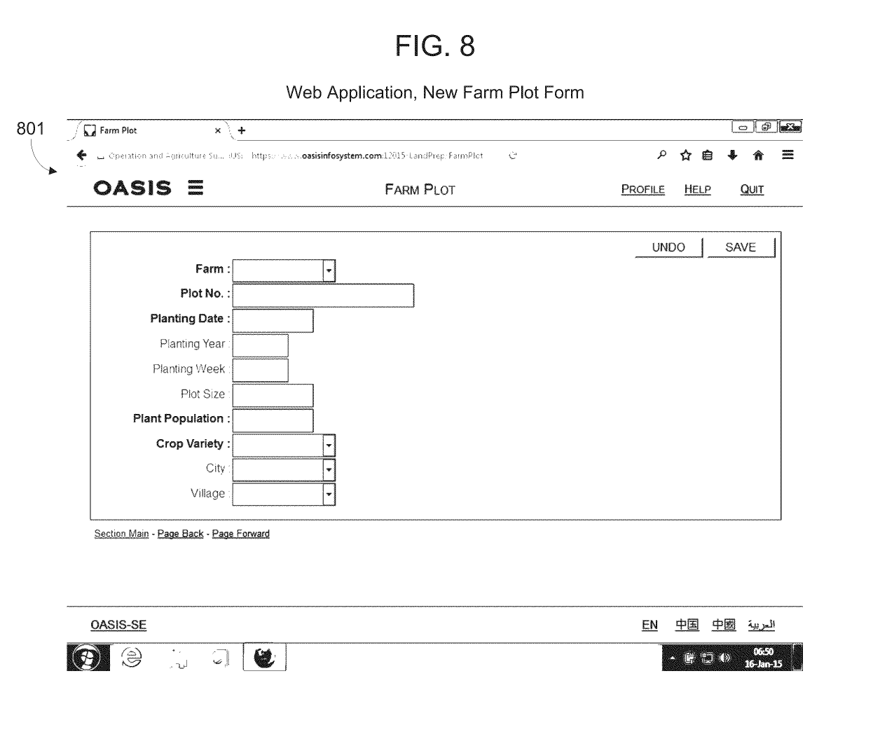

One particular data field called, FARM PLOT NO. 116, is used to link several subjects together 115 under the agricultural data category 101. This linkage 115 allows FARM PLOT NO. 116 to carry over land preparation 106, crop variety 107, water usage 108, crop protection 109, crop harvest 110, crop sampling 111, food packing 112, and food shipment 113. The associations will be apparent in drawings from FIGS. 8 to 19. Use of FARM PLOT NO. is a method of tracing and tracking an associated agriculture product across the agricultural production cycle, as well as a method to optimize future production. Note that under agricultural data 101, “crop” is interchangeable with “animal” or “fish” products as an alternative agriculture product under the present invention.

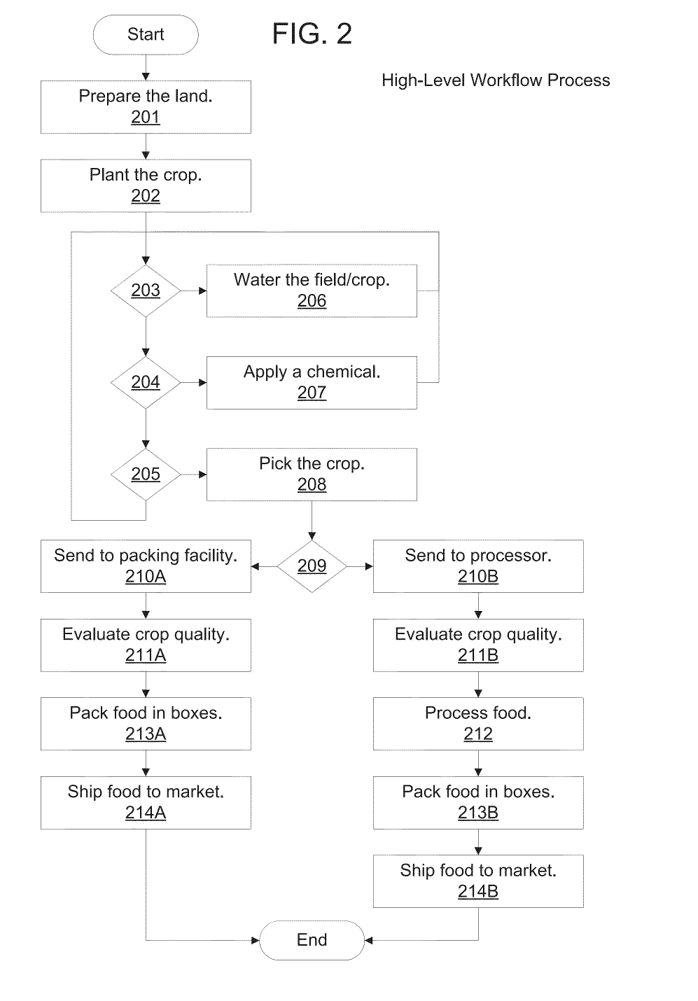

FIG. 2 is a business requirement and lends support for the purpose of the present invention. FIG. 2 shows a high-level workflow process of the agricultural production cycle. It is illustrated at a high level, because each step is a general step that inherently has detailed steps. For the purpose of this disclosure, a workflow process is illustrated to be quickly understood in context of the present invention. Note that the workflow process can relate to the production cycle for any agriculture product. For illustrative purposes, though, the workflow process is displayed as applied to a crop variety. At the start, a person prepares the land 201, and this step corresponds to land preparation 106. A person then plants the crop 202 with a chosen crop variety 107. A person makes a decision on whether the agriculture product needs water 203. If yes, a person carries out the task of providing water to the agriculture product 206, and records the activity in water usage 108. Watering may occur more than once. A person makes another decision on whether the agriculture product—namely, the crop—needs fertilizer, pesticide, or some other chemical 204. If yes, a person carries out the task of applying a chemical 207, and records the activity in crop protection 109. Chemical application may occur more than once. A person makes another decision on whether the agriculture product is ready for harvesting 205. If yes, a person carries out the task of harvesting the agriculture product, which again, for illustrative purposes, is picking the crop 208, and records the activity in crop harvest 110. Harvesting may occur more than once. If the agriculture product is not ready yet, a person continues to decide to provide water and to apply a chemical to the agriculture product until it is ready for harvesting. Note that like under agricultural data 101, “crop” as referenced under 202 through 208 is interchangeable with “animal” or “fish” products as an alternative agriculture product under the present invention.

After harvest, a person makes another decision on whether to send the harvest to a packing facility or a processor 209. If, a person decides to send the harvest to a packing facility 210A, the harvested agriculture product is checked in at the facility and recorded as received 112. One or more of the received agriculture products are selected at random and evaluated against selection criteria for quality control 211A, and the sampled agriculture products are recorded 111. The agriculture products then move through a preparation process to be packed in boxes 213A. The boxes containing the agriculture products are recorded 112. The packed boxes are further bundled together on pallets, and finally shipped to market 214A. The shipment information associated with the boxes containing the agriculture products is recorded 113.

The steps related to processing are similar to packing. If a person decides not to send the agriculture product to packing, the harvested agriculture product is then sent to a processor 210B, where the agriculture product is checked in at the processing factory and recorded as received 114. A unique identifier called, BATCH NO. is introduced to identify the agriculture product received for processing 114. One or more of the received agriculture products are selected at random and evaluated against selection criteria for quality control 211B. The sampled agriculture product items are recorded 111. The received agriculture products are processed, or converted, to become a new product 212. The processed agriculture products are packaged in boxes 213B. The boxes containing the processed agriculture products are recorded 112. The packed boxes are further bundled together on pallets, and finally shipped to market 214B. The shipment information associated with the boxes containing the processed agriculture products is recorded 113.

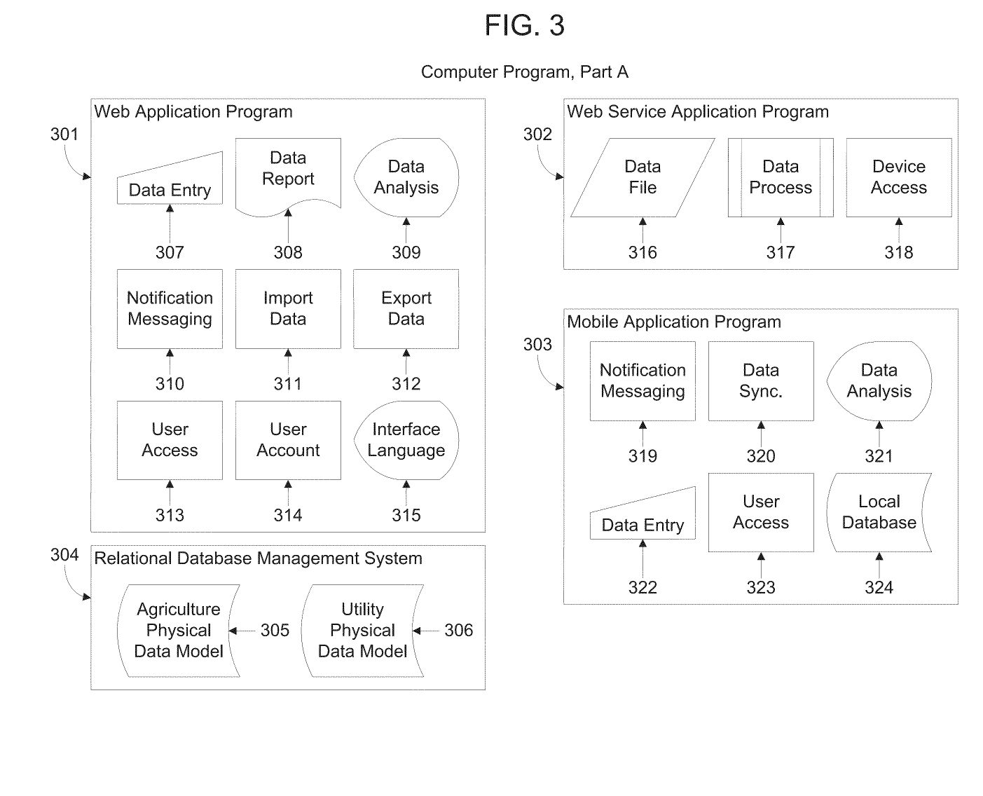

FIG. 3 shows the elements that are programmed in three computer software programs (a Web application 301, a Web service application 302, and a mobile application 303) and a relational database management system 304. The elements indicate what the programs and database are capable of doing, processing, displaying, generating, and/or operating. Three different computer programs provide the means by which to allow a user to access a relational database and handle data records in accordance with program instructions. A user may be a human or a machine. A machine user is a computer.

A Web application or Web-based application program 301 includes the following elements: data entry 307, data report 308, data analysis 309, notification and messaging 310, import data 311, export data 312, user access 313, user account 314, and interface language 315. Data entry is a form that consists of static text for description or labeling, one or more images, one or more text input fields, one or more check boxes that allow multiple selections, one or more radio boxes that restrict selection to one item, one or more drop-down or pull-down menu selection boxes, and/or one or more buttons 307. A data entry form may be as simple as a button to send a command or as complex to include several interactive elements in combination to allow processing several data fields in a single operation. Many data entry forms may be implemented as needed to enter and retrieve data records that span the entire logical data model. An example of a data entry form is shown in FIG. 8.

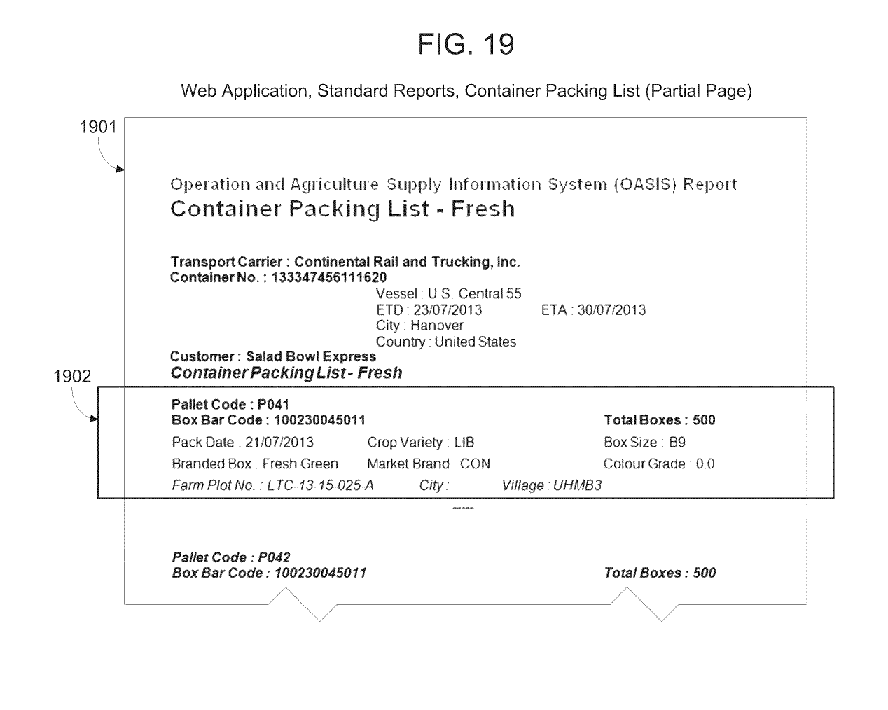

Data report generates a pre-formatted report in an electronic file that may be saved on a user's computer and edited by a user 308. A report may be generated from any subject in FIG. 1 to display the values of any set of pre-determined data fields. Two or more subjects in FIG. 1 may be joined to create a larger set of pre-determined data fields for a report. Many reports may be generated across all categories in FIG. 1. In its initial design, a report lays out content in a page layout that can be printed. As an electronic file, a report is produced in an RTF file format, a Microsoft Word file format, or another file format that can be read by a word processing program. A user may send a command to generate a report either by clicking a button on a simple form or by first selecting a specific data record and then clicking a button on a form. An example of a data report is shown in FIG. 19.

Data analysis displays the results of statistical analysis that may be graphical or tabular 309. Processing and calculating the statistics is carried out by program instructions in a background procedure hidden from a user but is initiated upon invocation by a user. A user may invoke data analysis to process data records and return the results, by sending a command, requesting a page, or starting a new session after login. A graph of a type that includes, but is not limited to, a column chart, bar chart, line chart, and pie chart, may be displayed on a page for immediate view. A table listing the calculated values in textual form may be displayed on a page for immediate view.

Notification and messaging provides different modes of communicating with registered users 310. The principal, default mode is internal messaging where all messages are created and viewed in the Web application. Messaging data entry forms are implemented to allow a user to send and view messages. Internal messaging retains messages in private without exposing messages to the public. A user may, however, send a message to a registered user by electronic mail (e-mail) or short message service (SMS). E-mail and SMS are alternative modes. Only users who have an account can send, receive, and view messages. Program instructions may execute upon an event to send a message automatically to a registered user in the form of an alert, a warning, or another type of notification.

Import data is a specialized data entry form that allows a user to add numerous data records from another source into a relational database at one time 311. A user selects a target data table, uploads a plain text file containing the new records, and submits the command. File contents are processed by program instructions in a background procedure to store the contents properly in the specified data table and in accordance with data integrity rules.

Data export is the reverse of data import, allowing a user to export numerous data records from a relational database to another source at one time 312. A user initiates data export by selecting a data table and submitting the command. Upon user initiation, program instructions execute in a background procedure to process data records in the specified data table, format the records in a pre-determined format, and produce a plain text file that may be saved on a user's computer.

For both import data and export data, a plain text file may have a text qualifier and/or be delimited by a comma, a tab space, or a pipe character.

User access restricts access to registered users and on elements 313. Restrictions may be further defined by a computer or network by a single IP address, a class or range of IP addresses, and/or a specific Internet domain name. User access provides controls on logging in, logging out, verifying credentials, establishing a session, accessing a page, accessing a particular data set, and executing an operation/command. Each user is assigned a user role that has certain rights and privileges that permit access to one or more elements. For example, a user may access a data report but not have access to import data. Similarly, a user may have access to data entry forms implemented in one subject but not have access to data entry forms implemented in another subject. Further, a user may only read data records but have no authority to make changes to any record. These user access scenarios are examples for illustrative purposes.

User account provides a set of data entry forms for managing all users in the form of a user account 314. A user account contains data records associated with a user. A user may register, edit, and close a user account. A user may also add, change, and delete a user role for a specified user.

Interface language displays data fields, screen labels, page titles, and other page content in a language preferred by a user 315. A user may change the current language to a different language in an instant for a single page or for the entire Web application. At the time of registering a new user account or editing user account details, a user selects a preferred language, which is the mechanism by which a Web application uses to display content in a language for all pages throughout a session. Preferred language setting may be overridden on the currently displayed page by selecting a different language located on the same page. Invoking a language change on a specific page only affects that page. Any number of languages and their varied dialects spoken by a local people/culture may be available for user selection.

In contrast to a Web application program, a Web service application program is a substantially simpler program that allows a machine user to transmit and process data records between two connected computers 302. A Web service application program has the following three elements: data file 316, data process 317, and device access 318. Data file contains data records formatted in a plain text file or in an XML file, and may be automatically generated or manually prepared 316. Data process is a set of program instructions developed as a self-contained independent Web application to operate entirely in a background procedure 317. A user may send a command to start a Web service. In most cases, a Web service is scheduled to execute at a specified time, to run one time or repeat several times, to start and end between specified dates, or to start on a specified date and run indefinitely. Device access 318 provides controls on computers, file locations, uniform resource identifiers (URIs), domain names, user credentials, and other elements that are involved in executing a Web service. Device access restricts access to the two computers involved in a Web service.

A mobile application or mobile app program 303 allows a user to access a relational database 304 from a hand-held computer such as a mobile phone, but there may be limited functions given a smaller screen size, reduced computing capacity, and/or other technical limitations. A mobile application is not intended to substitute a Web application but rather to complement a Web application. Notification and messaging 319 provides internal communications between registered users; further, it is the primary function that allows a user to view recent messages from a specified period and to send a new message. A message sent in a mobile application can be viewed in a Web application, and vice versa. Messages are stored and may be purged into a local database 324 on a hand-held computer.

Data records may be transmitted between a local database 324 and an agriculture physical data model 305, so that both databases contain identical records, by sending a data synchronization command. Data synchronization 320 executes program instructions in a background procedure for transmitting and processing data records between a local database 324 and an agriculture physical data model 305. Data analysis 321 follows similar logic with that in a Web application program 309. Data entry 322 implements data entry forms that are simpler and contain few interactive elements in comparison to a Web application program 307. Data entry forms are focused on specific tasks that a user may need in a situation where access cannot be made through a Web application. User access 323 is aligned with access rules and procedures in a Web application 313 to allow a registered user to use either a Web application or a mobile application. A user is required to use the same credentials to log in.

All three computer programs just described depend on a relational database management system that operates as the central database to store all data records 304. Two physical data models are managed by a relational database. A physical data model is a technical implementation of a logical data model in a computer program that is developed to operate a relational database management system and that applies the Structured Query Language (SQL) standard. Such a relational database application program may be provided by IBM, Microsoft, Oracle, or another provider, or may be open source. Agriculture physical data model 305 stores agricultural, administrative, and environmental data records as outlined in FIG. 1 and as designed in a logical data model 104. Utility physical data model 306 stores data records related to user account, user access, interface language, and data entry that are necessary for a Web application, a Web service application, and a mobile application to function.

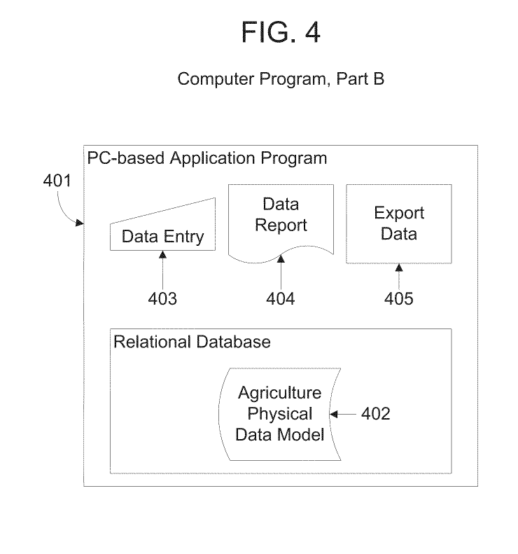

FIG. 4 shows the integration of a relational database within a computer program that executes on a desktop or laptop, personal computer (PC). A PC-based application program 401 allows a user to enter, store, and retrieve the same range of data records (in FIG. 1) without an Internet connection. All the elements consisting of data entry 403, data report 404, export data 405, and an agriculture physical data model 402 are developed in a single program. A PC-based application is a stand-alone application that operates independently of a Web application, a Web service application, and a mobile application.

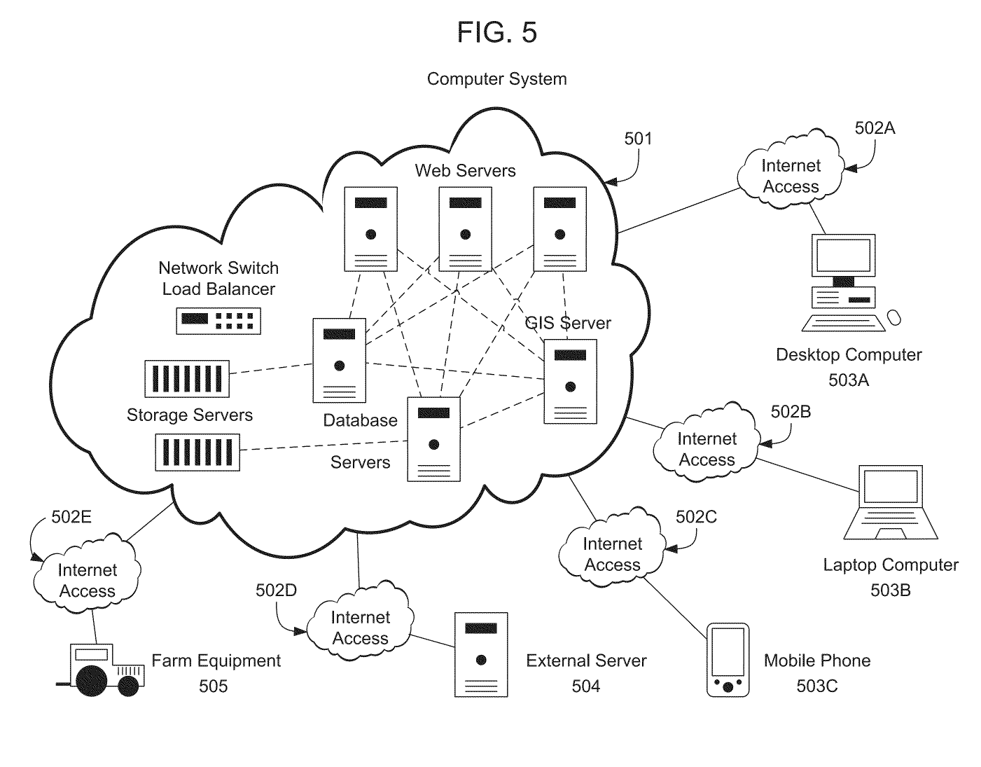

FIG. 5 shows the configuration of a computer system that executes a Web application program 301, a Web service application program 302, and a relational database management system 304. Although embodiments may take different forms, the preferred configuration is to operate at least seven (eight if GIS is required) special purpose computer servers all connected to an advanced network switch with load balancer functionality 501. The network switch may be connected to another network switch or to a network router to access the Internet. All computer servers are installed with an operating system application program that may be Microsoft Windows Server, Red Hat Enterprise Linux, or a Unix-based variation.

At least three Web servers are installed with a Web server application program that may be Microsoft Internet Information Services (IIS), Apache, or another Web server variation. Any middleware computer program needed to run a Web application and to connect to a relational database is also installed on the Web servers. Web servers should have identical software and hardware configuration with emphasis on a considerable amount of RAM to ensure that the Web application program 301 runs reliably on all servers.

At least two database servers are installed with a relational database application program that may be Microsoft SQL Server, Oracle, MySQL, or another SQL-compliant variation. Database servers should have identical software and hardware configuration with emphasis on having two or more physical microprocessor units. Data replication is configured either through native software functionality of a relational database program or by installing a third party computer program.

If mapping is a requirement, at least one Geographic Information System (GIS) server is installed with the specialized application program that may be Esri ArcGIS, Hexagon Geospatial ERDAS, or another GIS variation. Hardware configuration should have both a considerable amount of RAM and at least two physical microprocessor units. A GIS server is optional.

At least two storage servers are installed with several hard disk drives that are configured for speed, redundancy, and fault tolerance, and provide storage capacity in tens of terabytes or more. All user data and physical data models are stored on the storage servers. Alternatively, a storage system may be an external hard disk drive array that physically connects to a database server through a SCSI connection.

Dotted line links shown in 501 represent a process for how the different servers work together. Dotted lines are not physical connections; all servers are physically connected by a network cable to a specific port in a network switch. When a user makes a request to edit a data record, for example, the request is handled by the Web server. The Web server in turn relays the pertinent part of the request to the database server. The database server in turn processes the data record, by retrieving and manipulating the data from the storage server. The database server completes its task and sends a response to the Web server. The Web server receives the response from the database server and returns the results of the original request to the user. The entire process is carried out in milliseconds. All transactions between the Web server and the storage server are conducted in the background. The user's only direct interaction is with the Web server.

With regard to the GIS server, the Web server relays any request related to mapping to the GIS server. The GIS server processes the request, retrieving data from the database server. Results are returned to the Web server.

Duplicate Web servers ensure that numerous concurrent requests by numerous users can be handled quickly and processed with minimal error. A user will be redirected to another Web server, if one Web server is too busy. At least one Web server will remain operational, in the event that another Web server needs to be taken offline for maintenance. Duplicate database servers provide similar assurance. Duplicate storage servers provide an online backup of data. Load balancer functionality in a network switch manages connections and will redirect requests to the next available server.

The configuration of a computer system is designed to host numerous agricultural producers 501. A single service provider may operate all computer servers and allocate capacity for lease, rent, subscription, or another business arrangement to agricultural producers and other organizations. As the number of organizations increases, the number of computer servers will increase to support the additional load.

Alternatively, computer servers may operate entirely in a local area network for the exclusive use of a single organization. If an organization is relatively small with few users, all special purpose computer servers may be consolidated into one computer server.

What has been described in FIG. 5 thus far is a remote computer system 501. FIG. 5 further shows various Internet-connected devices that can access a remote computer system. A desktop personal computer 503A or a laptop personal computer 503B is the principal device. A user connects to a remote computer system through the use of a Web browser application program that usually exists on a user's computer. A Web browser application may include, but is not limited to, Microsoft Internet Explorer, Apple Safari, Mozilla Firefox, Google Chrome, and Opera. Internet access from a desktop computer may be through a local area network or a modem 502A. Internet access from a laptop computer may be through a local area network, a modem or a wireless Wi-Fi connection 502B.

A mobile application program 303 that is installed on a mobile phone 503C may be used to access a remote computer system. Internet access from a mobile phone may be through a telecommunications provider or a wireless Wi-Fi connection 502C. An external computer server 504 that operates in a separate location may access a remote computer system with a Web service application program 302. An external computer server may belong to an agricultural producer, a partner organization, or a third party organization. Internet access from an external computer server may be through a virtual private network (VPN), a local area network, or a modem 502D. An external computer server has an IP address that does not change. Computerized farm equipment 505 may access a remote computer system with a Web service application program 302. Internet access from computerized farm equipment may be through a wireless local area network or a wireless Wi-Fi connection 502E. Computerized farm equipment may have an IP address that does change.

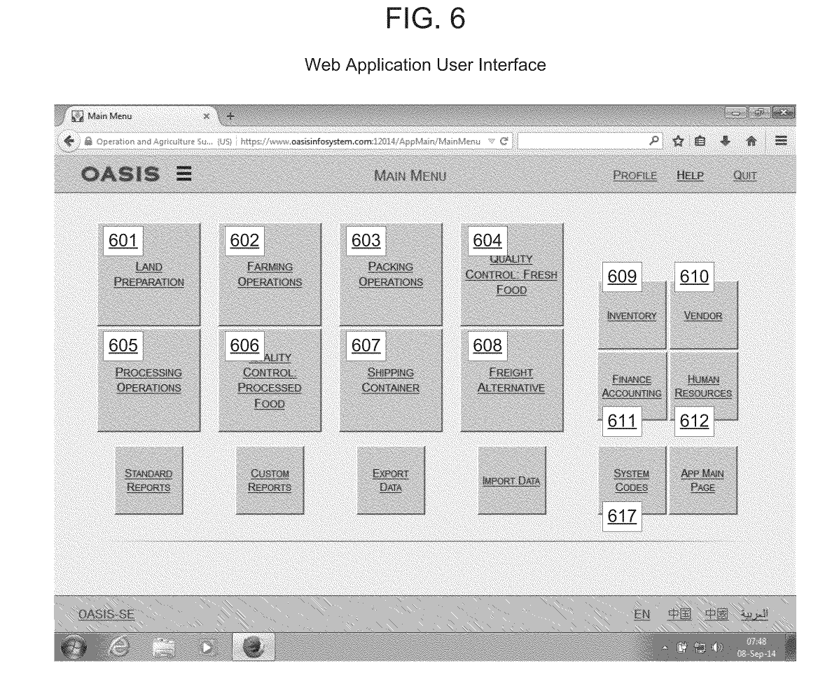

FIG. 6 shows the implemented main menu page of the current version of the Web application program 301, and is an example of a user interface in which a user may access a remote computer system. A user may go to any section to read, add, edit, and/or delete data records related to that section. Land Preparation section 601 contains data records related to land preparation 106. Farming Operations section 602 contains data records related to water usage 108, agriculture product protection 109 and agriculture product harvest 110. Packing Operations section 603 contains data records related to packaging the agriculture product 112. Quality Control Fresh Food section 604 contains data records related to packaging 112 and sampling 111 the agriculture product. Processing Operations section 605 contains data records related to processing 114 the agriculture product. Quality Control Processed Food section 606 contains data records related to processing 114 and sampling 111 the agriculture product. Shipping Container section 607 and Freight Alternative section 608 both contain data records related to agriculture product shipment 113 as a shared resource. Inventory section 609 contains data records related to inventory management 117. Vendor section 610 contains data records related to vendor management 118. Finance Accounting section 611 contains data records related to financial management 119. Human Resources section 612 contains data records related to human resources 120.

System Codes section 617 contains numerous background data records that have to exist in a relational database before any of the above mentioned records can be entered. Background data records are sources to populate drop-down or pull-down menus in the data entry forms to make it easier to enter and change data. For example, to ensure that the name of a specified variety of an agriculture product remains consistent in spelling across all applicable records, an agriculture product variety code is defined and used in place of its full name for convenience on applicable records. All associated records will look in the source agriculture product variety data table to get the details—the same details. A user may define a agriculture product's variety and other system codes in accordance with that user's operating convention. Crop (or other agriculture product) variety 107 among numerous other background data records is accessible in System Codes section 617.

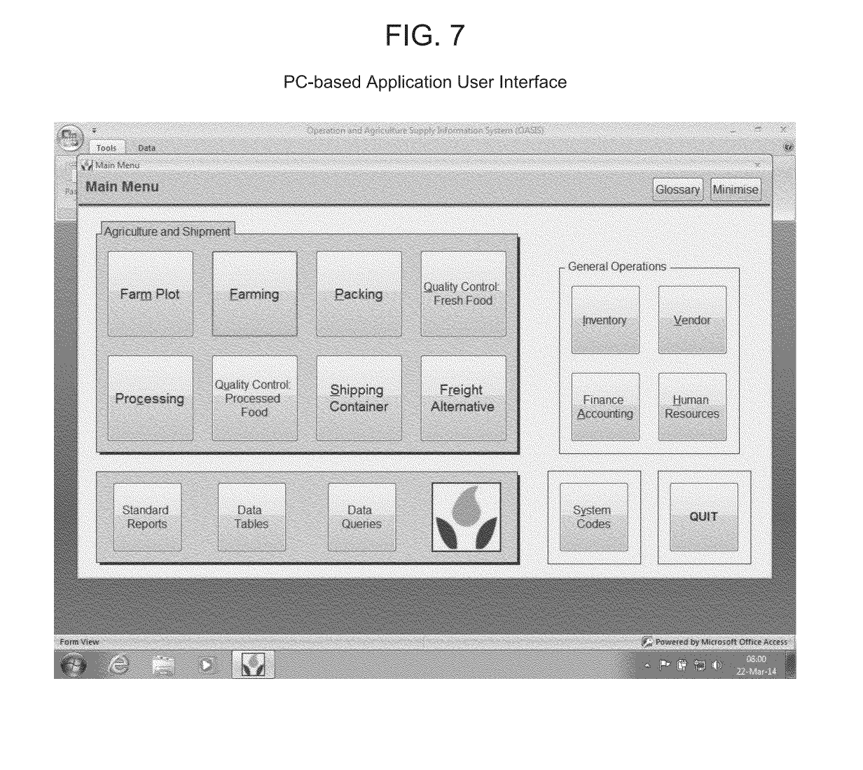

FIG. 7 shows the implemented main menu screen of the current version of the PC-based application program 401, and is disclosed to compare the variation with that of FIG. 6. A computer program product can reflect slight differences, because a different programming language and/or software development environment can have varied techniques and approaches to developing elements. In the middle of a current project, an idea may arise that with deeper thought may be planned for a future version. Then a new version may change as a result of incorporating a new idea. Despite such change and variation to user and program functionality, a logical data model 104 remains the same in both Web-based 301 and PC-based 401 application programs.

FIGS. 8 to 19 show by sample data and a series of views a method of tracing and tracking an agriculture product across the agricultural production cycle. Note that in each of those figures, “crop” is interchangeable with “animal” or “fish” products as an alternative agriculture product under the present invention.

In FIG. 8, 801 shows a data entry form for adding a new farm plot record. A user may define FARM PLOT NO. in accordance with their operating convention. For each farm plot, a user selects a crop variety that is planted. As described above, crop variety is a drop-down or pull-down menu in which a user had already defined all crop (or animal or fish) varieties in System Codes. Selecting a farm is also done by a drop-down or pull-down menu. A farm, which is a specific vendor type, is entered as a vendor in vendor management. A new farm plot record is stored when a user completes all required fields and clicks the SAVE button.

In addition to assigning a farm plot to a specific land area, as noted herein, a farm plot may also be an artificial or natural body of water that is clearly demarcated and intended for the management of fish-stock or other seafood. An artificial water body may be a construction built into or raised above the earth. A natural water body may be a part of a river, a lake, or a larger body that is a natural water reservoir, or it could be a part or particular location of such water body. This also includes a reservoir that is separated by an underwater fence or similar barrier. In this context, “Plot Size” is the covered area of water as measured by the fixed boundary of the water body.

In the case where the farm plot is used to manage animals, label meanings will change, of course, given the different context. “Planting Date” changes to “Assignment Date” or the like to refer to the date on which the animal has been placed on or assigned to the farm plot. “Planting Year” changes to “Calendar Year”. “Planting Week” changes to “Calendar Week”. “Plant Population” changes to “Animal Population”, “Herd Population”, or the like. “Crop Variety” changes to “Animal Variety”. In the case where a user manages both plants and animals: “Crop Variety” changes to “Crop/Animal”; “Planting Date” would change to “Planting/Assignment Date”; and “Plant Population” would change to simply “Population”. All changes are simply word changes that are displayed on the user interface. The design of the data model does not need to be changed.

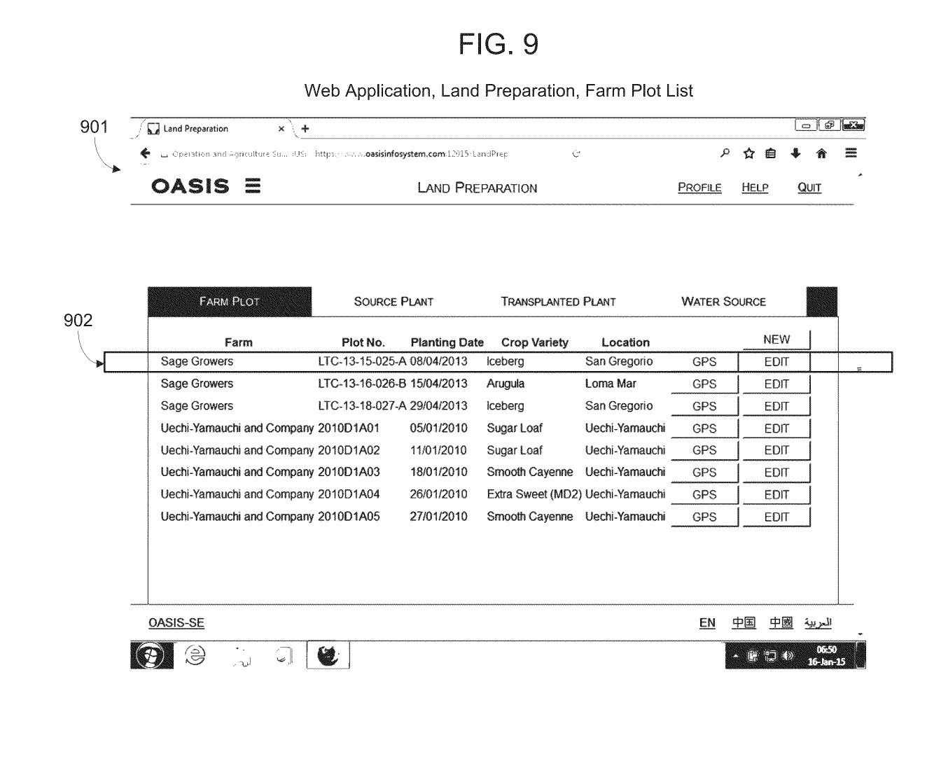

In FIG. 9, 901 shows a list of farm plot records. The highlighted record that focuses on FARM PLOT NO. LTC-13-15-025-A is a reference for demonstrating the tracing method in this disclosure 902.

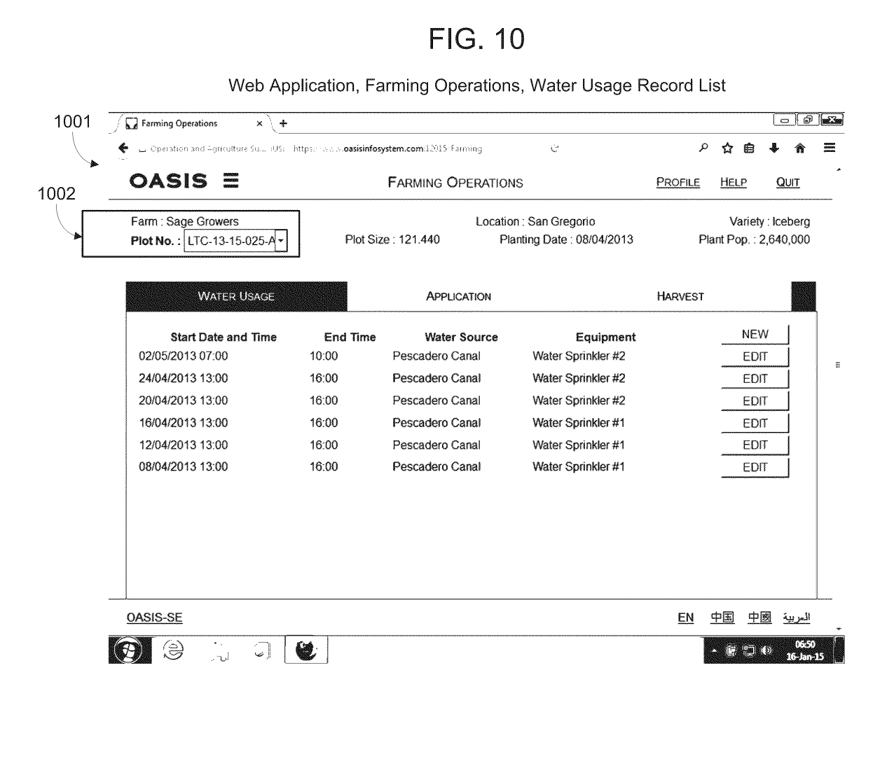

From FIGS. 9 to 10, a user moves from land preparation to farming operations. FIG. 10 (1001) shows a list of water usage records that are associated with LTC-13-15-025-A. The referenced farm plot is highlighted 1002.

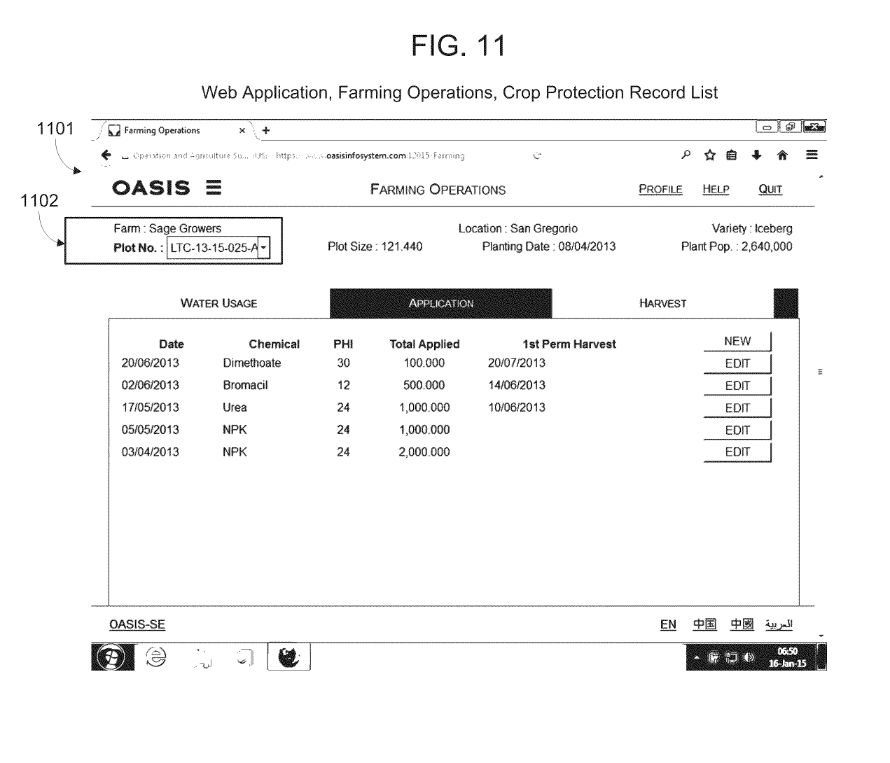

In FIG. 11, 1101 shows a list of crop protection records that are associated with LTC-13-15-025-A. The referenced farm plot is highlighted 1102.

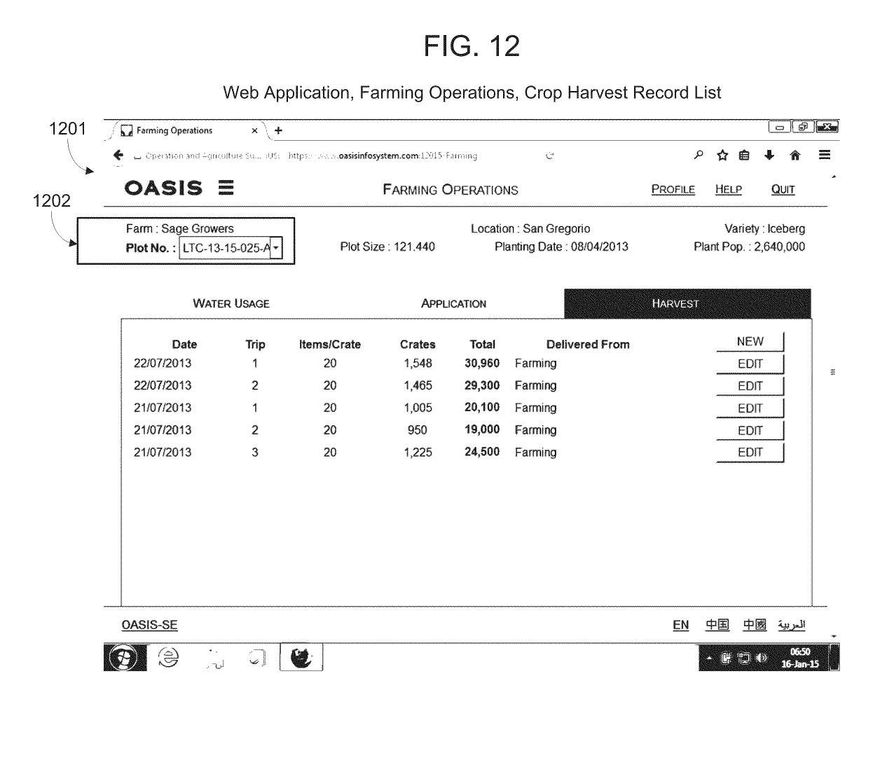

In FIG. 12, 1201 shows a list of crop harvest records that are associated with LTC-13-15-025-A. The referenced farm plot is highlighted 1202.

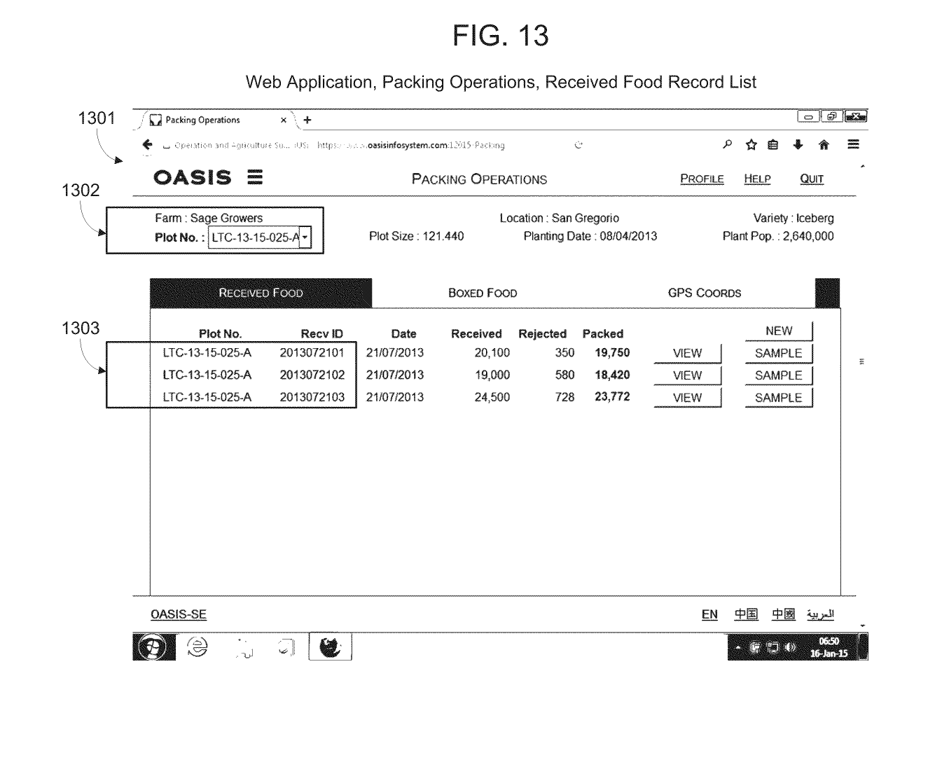

From FIGS. 12 to 13, a user moves from farming operations to packing operations. Note that in FIGS. 13 through 17, “food records” are records relating to the agriculture products—crop, animal, or fish—that the user had defined in “Crop Variety” 107 in System Codes 617. “Food records” may also be used to track operations related to agriculture products not intended for consumption, such as, but not limited to, cotton or tobacco crop varieties, or switch grass or other animal feed crops. FIG. 13 (1301) shows food records that are associated with LTC-13-15-025-A and that had been received at a packing facility. The referenced farm plot is highlighted 1302. The list further highlights 1303 that each record is assigned a unique identifier named, RECV ID. RECV ID is a secondary identifier to associate a specific agriculture product sample. At this point, FIG. 13 is considered at Pre Packing stage where the agriculture product is checked in at a facility.

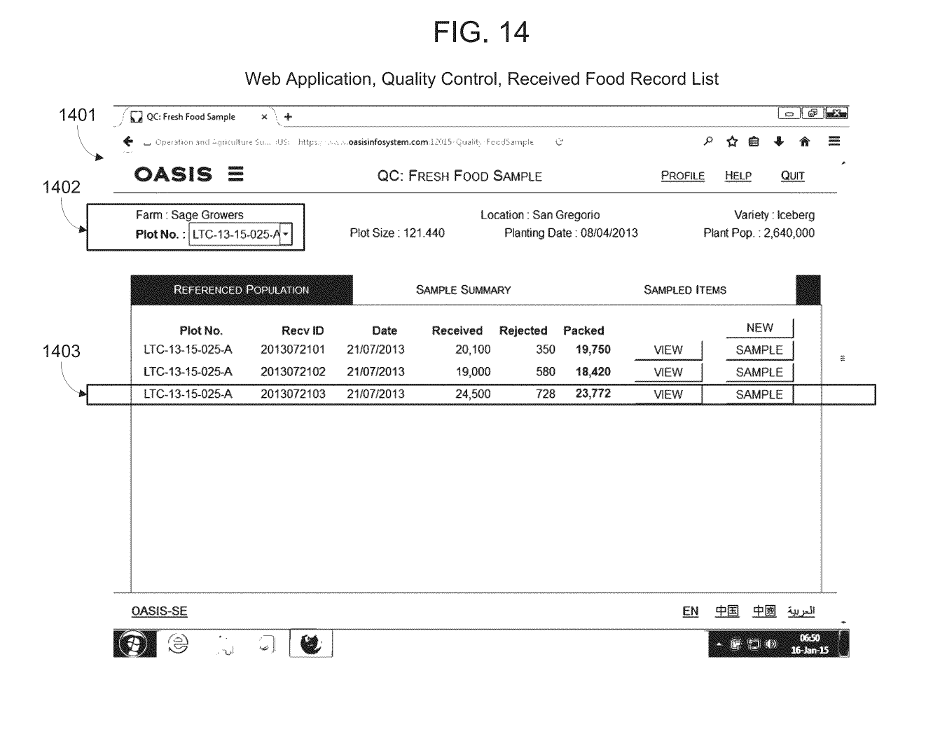

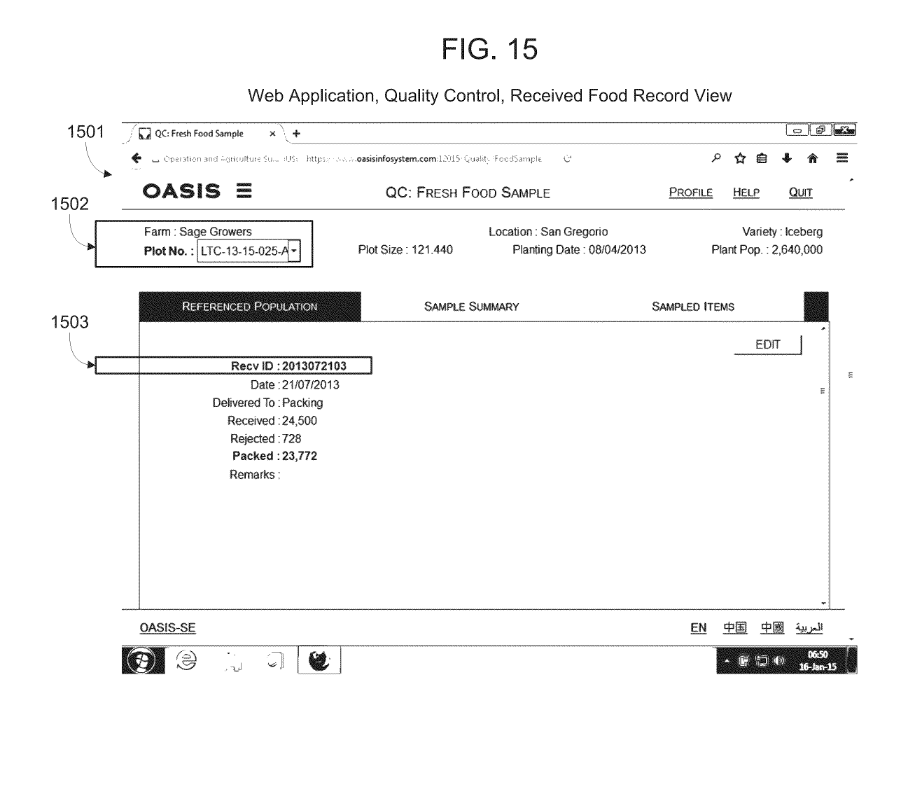

FIG. 14 moves to sampling the agriculture product, and 1401 shows received food records that are associated with LTC-13-15-025-A and that are presented in context of evaluating food quality. The referenced farm plot is highlighted 1402. Because each received food record may have its own sample, the referenced RECV ID record is highlighted for this disclosure 1403. After a user clicks on the SAMPLE button, the page changes to FIG. 15 to show details of the selected received food record 1501. The referenced farm plot is highlighted 1502. The RECV ID field is highlighted 1503 to confirm that the page loaded correctly from the previous page.

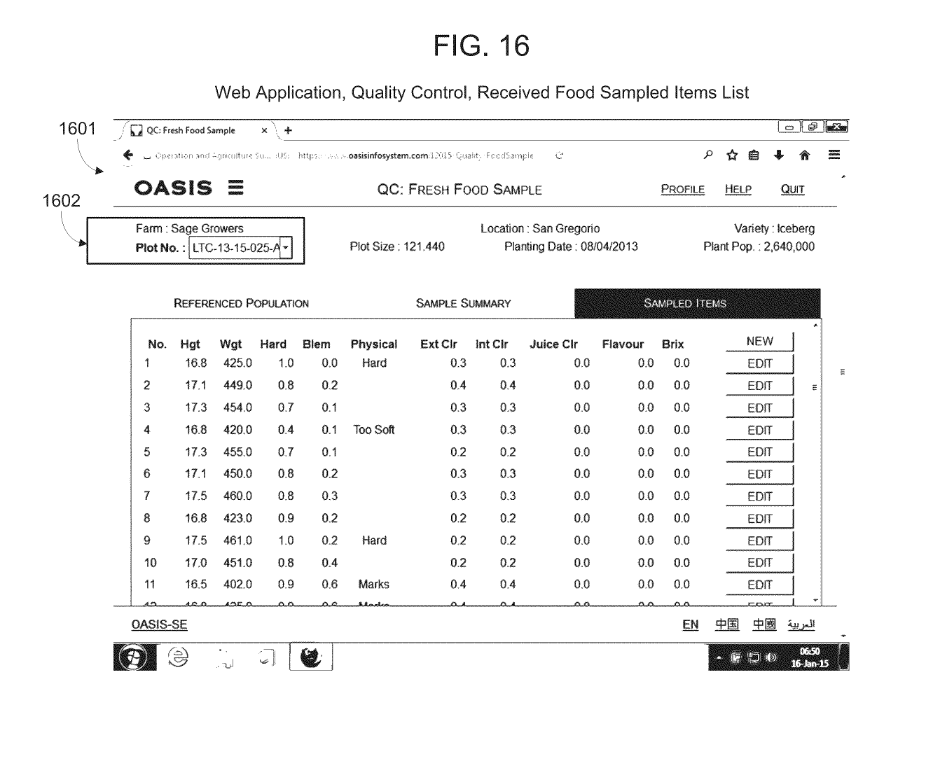

In FIG. 16, 1601 shows a list of sampled food items that are associated with the selected received food record. The referenced farm plot is highlighted 1602. Some fields used in evaluating food items are optional.

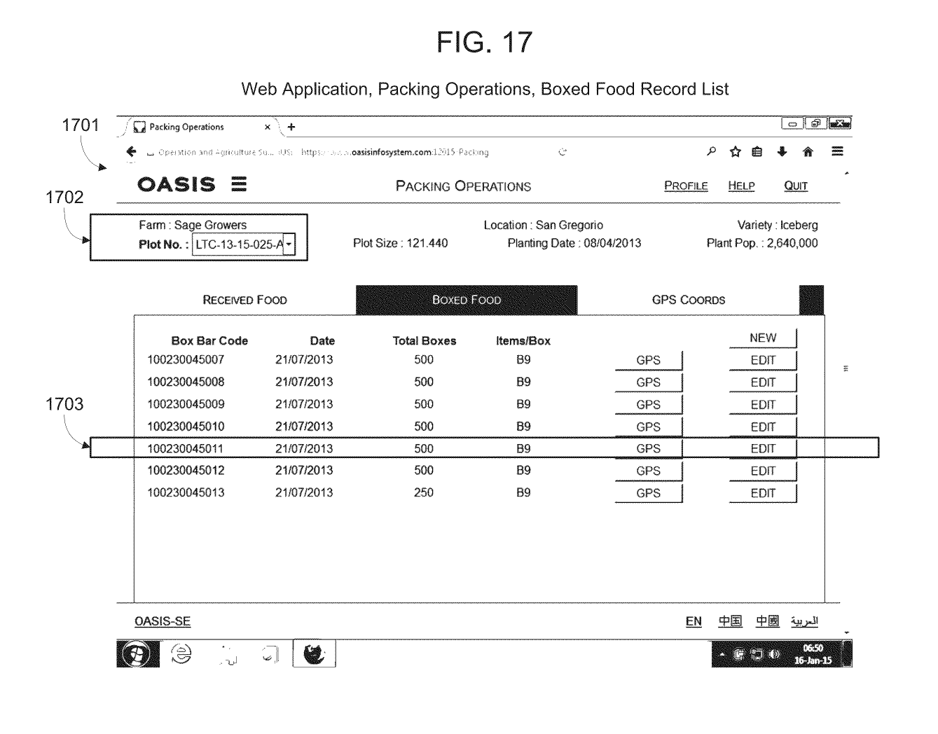

From FIGS. 16 to 17, a user returns back to packing operations from agriculture product sampling. In FIG. 17, 1701 shows a list of boxed food records that are associated with LTC-13-15-025-A. The referenced farm plot is highlighted 1702. At this point, a unique identifier named, BOX BAR CODE, may be assigned to one or more individual boxes in accordance with a user's operating convention. In this example, a group of food boxes is assigned the same code. The highlighted BOX BAR CODE record 1703 is a reference for FIG. 19.

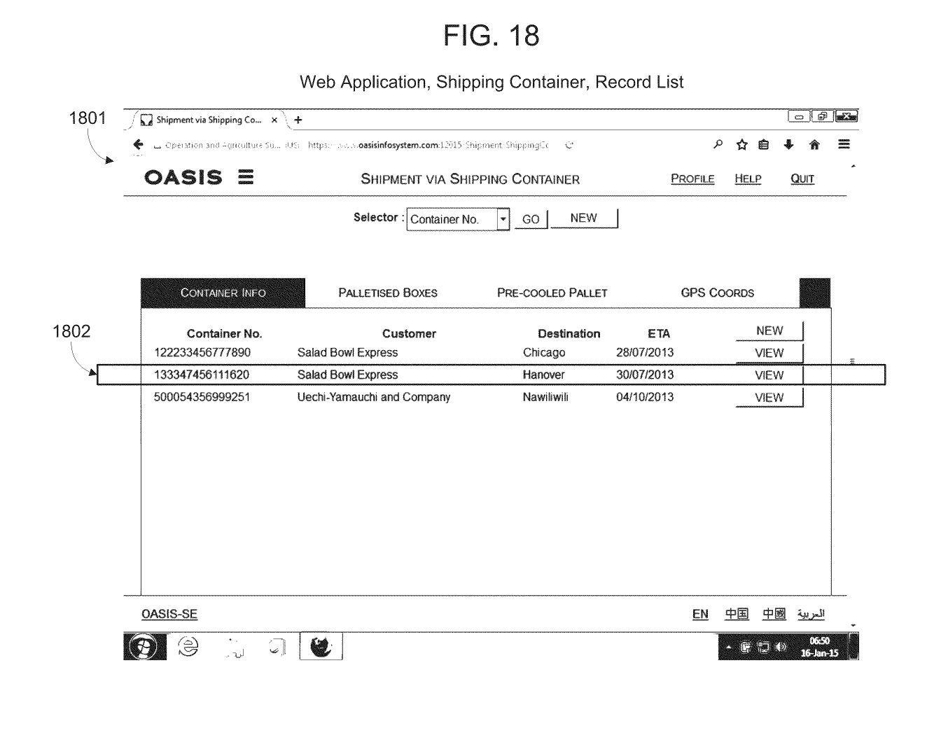

From FIGS. 17 to 18, a user moves from packing operations to shipment. In FIG. 18, 1801 shows a list of shipping containers. The field named, CONTAINER NO., which is provided by a transportation company, is highlighted for reference 1802. Each container record describes the customer, destination, estimated time of departure, and estimated time of arrival, among other data fields, relating to the agriculture product.

FIG. 19 shows a pre-formatted standard report. After additional records related to bundling food boxes on pallets had been recorded, a user may save a shipping container packing list 1901. A packing list document presents all boxed food records organized by shipping pallet that are associated with CONTAINER NO. and that are associated with FARM PLOT NO. The highlighted pallet shows the referenced farm plot where the packaged food originally came from 1902.

FIG. 20 shows a portion of a logical data model 104, focusing on post-harvest and shipment. Data relationships are drawn to show how the data tables are related 105. Starting with farm 2001, one farm record may have many farm plot records stored in farm plot 2003. One farm record may have many GPS coordinates stored in GPS coordinates 2009. Many GPS coordinates create a shape or boundary of the farm. One farm record may have many food processing records in food processing 2004. With regard to food processing, a supplier is not limited to a farm and includes any vendor that is defined in vendor management 118. One crop (or animal or fish) variety record 2002 may be associated with many farm plot records stored in farm plot 2003. One crop variety record 2002 may be associated with many food processing records stored in food processing 2004. One farm plot record may have many GPS coordinates stored in GPS coordinates 2009. Many GPS coordinates create a shape or boundary of the farm plot. One farm plot record may have many boxed food records stored in boxed food 2005. One food processing record may have many boxed food records stored in boxed food 2005. One boxed food record may have many GPS coordinates records stored in GPS coordinates 2009. Several GPS coordinates associated with a food box indicate movement across time during shipment. One intermodal shipping container record 2007 may have many pallet records stored in shipping pallet 2006. One pallet record may have many boxed food records stored in boxed food 2005. One intermodal shipping container record may have many GPS coordinates stored in GPS coordinates 2009. Several GPS coordinates associated with a shipping container indicate movement across time in transit from origin terminal or port to destination terminal or port. As an alternative to a shipping container, one freight record 2008 may have many pallet records stored in shipping pallet 2006. A freight alternative is available for a load that does not require a shipping container.

GPS coordinates 2009 is the source for mapping all related properties in a Geographic Information System (GIS). Properties include, but are not limited to, farm, supplier, vendor, farm plot, water source, food box, shipping container, employee, province/state, district/county, city, township/town, village, and cottage. Highlighting the difference between farm and farm plot, a set of GPS coordinates can be associated with the specific location of a farm's principal office, as well as any physical building or site facility. A set of GPS coordinates can also be associated with a specific farm plot, whether it be a parcel of land (for crop or livestock) or a body of water (for fish-stock). All sets of GPS coordinates can then be collected to indicate the entire property holding including both land and water bodies if applicable.

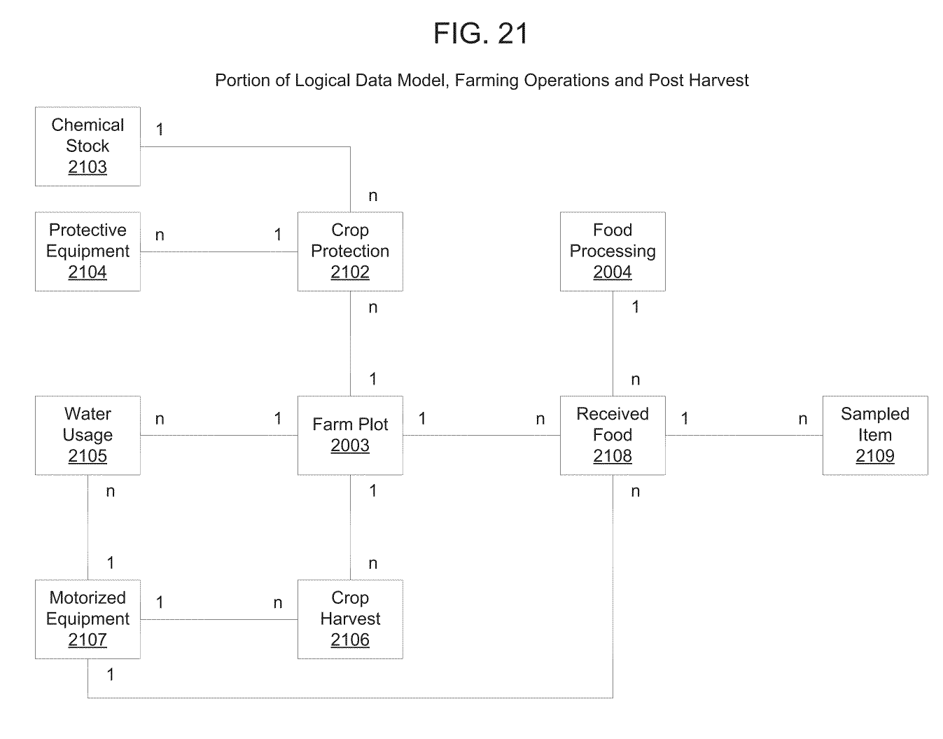

FIG. 21 shows another portion of a logical data model 104, focusing on farming operations and post-harvest. Starting with farm plot 2003, one farm plot record may have many water usage records stored in water usage 2105. One farm plot record may have many crop protection records stored in crop protection 2102. One farm plot record may have many crop harvest records stored in crop harvest 2106. One farm plot record may have many received food records stored in received food 2108. Similarly, one food processing record 2004 may have many received food records stored in received food 2108. One received food record may have many sampled food item records stored in sampled item 2109.

Growth and post-harvest operations involve supplies and equipment. Inventory management maintains a set of data tables related to stock supplies and equipment assets 117. Motorized equipment stores records of a specific category of equipment, such as a tractor, a truck, or a water pump 2107. Protective equipment stores records of a specific category of equipment, such as a pair of safety glasses, a pair of gloves, or a coverall, that a person wears to provide protection against occupational hazards 2104. Chemical stock stores records of a specific category of supply, such as a fertilizer, a pesticide, or a fungicide 2103. One chemical stock record may be associated with many agriculture products'—namely, crops'—protection records stored in crop protection 2102. Many protective equipment records may be associated with one crop protection record stored in crop protection 2102. One motorized equipment record may be associated with many water usage records stored in water usage 2105. One motorized equipment record may be associated with many harvest records stored in crop harvest 2106. One motorized equipment record may be associated with many received food records stored in received food 2108.

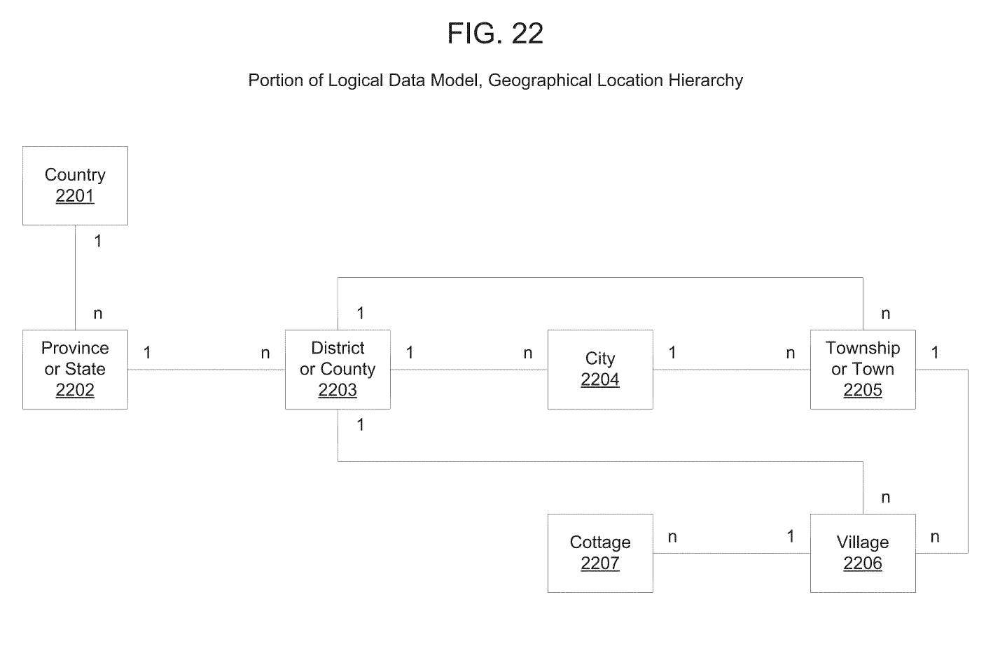

FIG. 22 shows a portion of a logical data model 104, focusing on geographical location 121 to show a hierarchical structure that starts at the national level and ends at the person level. Starting with country 2201, one country record may have many province/state records stored in province 2202. One province/state record may have many district/county records stored in district 2203. One district/county record may have many city records stored in city 2204. One city record may have many township/town records stored in township 2205. One township/town record may have many village records stored in village 2206. One village record may have many cottage records, which may include a person, a family, a household, an estate or a plantation, stored in cottage 2207.

Alternative relationships are available for township and village in cases where a relationship cannot be made at the next higher level. One district/county record may be associated with many township/town records. One district/county record may be associated with many village records.

The structured levels of jurisdictions is particularly advantageous for land surveyors and government agencies—especially in developing and emerging countries—to formalize boundaries and to aid in resolving land or territorial disputes. The lower levels, the village in particular, is where farms are likely to be located with respect to developing and emerging countries.

FIG. 23 shows a portion of a physical data model 305, focusing on land preparation. FIG. 23 further provides a few exemplary data tables to show how data fields are defined with specified machine readable names, data types, and other attributes. Each data field has a name that is kept short and does not contain any space, designed to be quickly read by a computer. Each data field has a data type that informs how the value is treated and what constraint is on the value. A data field may be null or required to have a value. At least one data field has a primary key attribute, which indicates that the field's value must be unique relative to all records in the same data table. A primary key sets up a relationship whereby the connected data field in the second data table becomes a foreign key. As a matter of general convention, the two data fields that are bound in a relationship have the same name. The key icon shown in FIG. 23 is a primary key.

Farm plot is one data table that stores all farm plot records 2301. As described above, a farm plot may be based on land (for managing crop or livestock) or in water (for managing fish-stock). Crop variety is one data table that stores all crop variety records 2302. The crop variety data table is adaptable to storing a plant variety or an animal or fish variety (species). It is adaptable because of the field named, CRTYPEID. CRTYPEID is linked to another data table (not shown) where the user can define types of a higher order such as seed, genetically modified organism (GMO) seed, grain, fruit, nut, cattle, chicken, fish, and shellfish. Listed types are for illustrative purposes. As described above, the label, “Crop Variety” can change depending on the context. And so, the use of “crop” is interchangeable with “animal” or “fish” products depending on the agriculture product variety that the user selected for tracking and optimization. The names of the data fields shown in the data tables do not necessarily have to change, since they are not normally seen or read by a human. A relationship between farm plot and crop variety is made by the field named, CROPID.

Farm location is one data table that stores location records associated with farm plots 2303. A relationship between farm plot and farm location is made by the field named, PTNUMEXT. As PTNUMEXT is a primary key in both farm plot and farm location, there is a one-to-one relationship. One farm plot can only be in or near one village. Village is one data table that stores all village records 2304. A relationship between farm location and village is made by the field named, VILLAGEID.

Farm location is an additional data table, different from GPS coordinates. While GPS coordinates records are more precise, farm location is an incorporated, unincorporated, or informal jurisdiction. A user may associate a city, a village, or both a city and a village with a farm plot (as shown in FIG. 8).

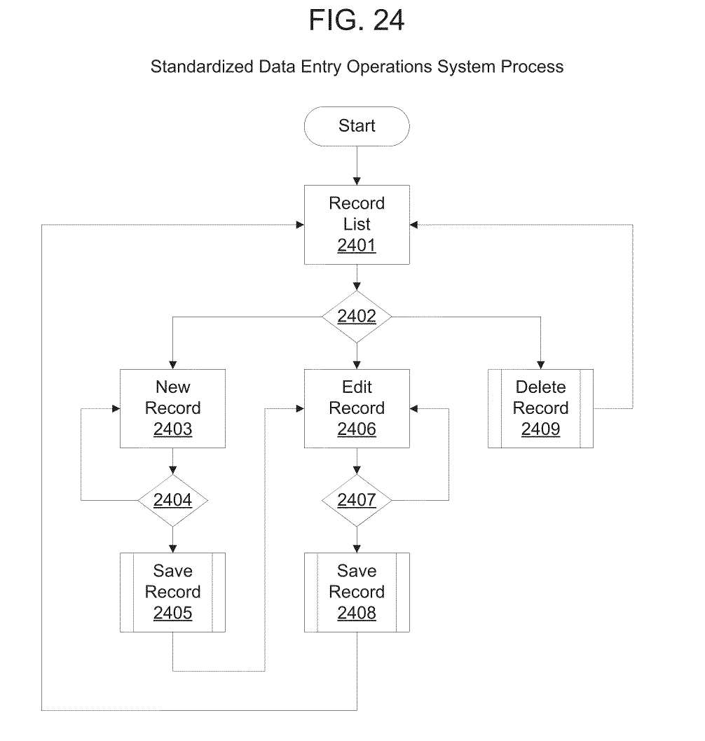

FIG. 24 shows a system process flowchart for developing data entry operations in a standardized way for all data entry forms. A user may add a new data record, edit an existing data record, or delete an existing record on any data entry form. As there may be numerous forms, a system process allows a software developer to develop the data entry operations quickly and in a manner that stays consistent across all forms. At the start, a record list page displays, presenting a list of data records 2401. For each record, there may be one or two buttons to allow a user to edit and/or delete the record. Another button to add a new record may be displayed. Add, edit, and delete operations are available, if a user has rights to carry out the operations. While a record list is being viewed, a user makes a decision to add, edit, or delete a record 2402. On deciding to add, a new record page displays a blank form 2403. A user fills out the form and submits the data for saving. Before saving, program instructions in a background procedure perform validation checks on the data 2404. Any error will not save the record and will return back to the new record form. If there are no errors, program instructions in a background procedure execute to save the new record 2405. A user is then taken to an edit record page where a form is displayed and pre-filled with the selected record's stored values 2406. In an alternative path, a user may be taken back to the record list page where the newly saved record is among the list 2401.

On deciding to edit 2402, an edit record page displays with a form that has its fields pre-filled with the selected record's stored values 2406. A user makes any needed changes and submits the data for saving. Before saving, program instructions in a background procedure perform validation checks on the data 2407. Any error will not save the record and will return back to the edit record form. If there are no errors, program instructions in a background procedure execute to save the changes made to existing values 2408. A user is then taken to a record list page 2401. In an alternative path, a user may be taken back to the edit record page where the pre-filled values will show the saved changes 2406.

On deciding to delete 2402, a user sends a command that invokes program instructions in a background procedure to delete the specified record 2409. After the procedure has been completed, the record list page reloads to confirm that the just deleted record is no longer among the list 2401.

The current version of the Web application in this disclosure restricts the delete operation to a few data entry forms, because of a business requirement.

FIGS. 9 to 18, except FIG. 15, are examples of record lists. Some record lists have command operations that will display another list or display the selected record's details in a read-only view form. FIG. 15 is an example of a read-only view record form. FIG. 8 is an example of a new record form, presenting all fields blank. An example of an edit record form uses the same new record form and displays stored values in the corresponding fields as new defaults.

The present invention discloses its business and functional requirements as principles for implementing the present invention. Drawings of a computer system and a computer program have been presented to understand and demonstrate the principles and practical application of the invention. The description is not intended to be exhaustive and limited to the form of the invention disclosed. Those skilled in the art will appreciate that the present invention may have modifications and variations by way of selecting and using a computer programming language, a computer server application program, a certain quantity of capacity in computer hardware components, or other computer technology. While such technical details may change a computer system or a computer program, technical details still follow the principles outlined in business and functional requirements.

The present invention serves primarily farmers who grow and/or process edible plant-based farm products for human consumption and/or animal feed. It can also serve farmers who grow and/or process inedible plant-based farm products for various industries such as pharmaceutical manufacturing and alternative energy. Since the production cycle is related to non-plant-based farm products, other producers who manage animal variety agriculture products could use the present invention to their advantage. Similarly, other producers who manage fish variety agriculture products could also use the present invention to their advantage. Certain features may not be applicable and thus can be left unused. The labeling of terms is minor. In similar manner to what was described above related to interface language 315, screen labels may be edited for a particular producer and displayed as the preferred language for that producer. Because the logical data model splits all information into multiple data tables (creating smaller manageable parts) 104, new, unforeseen data requirements—namely, new data fields—can be easily inserted as additional linked data tables without damaging the integrity of the system. The underlying design of the data management system remains flexible to accommodate different agriculture products beyond the range of plant crops.

The different information recorded for a selected crop variety can also be easily adjusted if a user wished for instance, to track certain parameters relating to a livestock or fish-stock variety instead. The present invention disclosed recording activities related to a crop variety such as land preparation, plant watering, and chemical application. If a user wished instead to track and/or optimize productivity related to a livestock variety, the user could substitute the information above related to the crop variety with information such as land area used for grazing, water and food consumption, and air quality as relevant to the selected livestock variety. To the same extent, information such as water temperature and pollutant exposure could be substituted to track and/or optimize quality of a desired fish-stock variety.

1. A computer-based system for improved processing of information related to origin, production and distribution of an agriculture product during the entire term of an agricultural production cycle from land preparation to a final destination for sale to consumers, comprising:
one or more special purpose computer servers designed to serve as a storage server for storing data records in accordance with a logical data model and connected electronic storage that stores computer-executable instructions and data that is used by the computer-executable instructions, wherein the one or more special purpose computer servers, computer-executable instructions and data, together, configure the system to collect information by way of network connections, and process the information to provide processed tracking information of agriculture product origin, production and distribution; with the one or more special purpose computer servers configured for conducting the following steps:
collecting various, diverse agricultural, administrative and environmental data from personal computers, mobile phones, farm machines and third party computer servers, wherein the collecting of data includes:
assigning a single unique identifier in the form of a Farm Plot Number to the agriculture product first planted or managed at an origin site;
compiling daily farming activities for the agriculture product, and associating the compiled activities to the agriculture product via the Farm Plot Number;
compiling harvest activities related to the harvesting of the agriculture product at the origin site, and associating the compiled activities to the agriculture product via the Farm Plot Number;
compiling post-harvest activities for the agriculture product, and associating the compiled activities to the agriculture product via the Farm Plot Number;
compiling additional records and modified existing records as to daily farming activities, harvest activities and post-harvest activities for the agriculture product, and associating the compiled records to the agriculture product via the Farm Plot Number;
maintaining all data association with the Farm Plot Number without changing or modifying the Farm Plot Number during the entire term of the agricultural production cycle;
storing and maintaining all compiled data in association with the Farm Plot Number in a single database for the entire term of the agricultural production cycle;
compiling the data in a single database to establish how the agriculture product originated and was produced from its farm source origin to a final destination for sale, wherein the data is compiled via using a single user input of the Farm Plot Number by which all data associated with that Farm Plot Number is included for compilation; and
generating a report summarizing the compiled data to authenticate all activities related to the agriculture product's origin, production and distribution, wherein the server generated report is produced upon receiving a single user input of the Farm Plot Number by which all data associated with that Farm Plot Number is included for compilation and is then presented on a graphical user interface or outputted in a printed form;
wherein the compiled data improves the functioning and performance of the computer servers by reducing to a minimum the number of times necessary to access and retrieve all of the compiled data by querying the computer servers with the Farm Plot Number.

2.-6. (canceled)

7. The computer-based system of claim 1, wherein the one or more special purpose computer servers are further configured for conducting:
processing the agriculture product for shipment;
compiling packing activities related to the packing of the agriculture product, and associating the compiled activities to the agriculture product via the Farm Plot Number;
compiling shipment information of the agriculture product, and associating the shipment information to the agriculture product via the Farm Plot Number; and
providing a listing of the compiled information on the shipped agriculture product to confirm for consumers the creation, processing and tracking of the agriculture product from its origin site to final point of sale, wherein the server generated listing is produced upon receiving a single user input of the Farm Plot Number by which all data associated with that user input is included for compilation.

8. The computer-based system of claim 1, wherein the one or more special purpose computer servers include a database server for organizing and managing all the collected data in a single, relational database as defined in a logical data model; and a Web server for handling, processing and completing requests from the personal computers, mobile phones, farm machines or third party computer servers.

9. The computer-based system of claim 8 further comprising:
a Web application computer program product for human users to send and retrieve data records manually through a graphical user interface between the computer system and a personal computer;
a Mobile application computer program product for human users to send and retrieve data records manually through a graphical user interface between the computer system and a mobile phone;
a Web service application computer program product for farm machines to transmit and process data records automatically through an automated scripted procedure between the computer system and a farm machine equipped with a computer; and
a Web service application computer program product for business partners to transmit and process data records automatically through an automated scripted procedure between the computer system and an external, third party computer server,
wherein the combined computer programs together improve the functioning and performance of the computer servers by providing alternative interfaces and procedures tailored to collect data both manually and automatically from the various users.

10. A computer-based method for processing information related to origin, production and distribution of an agriculture product, wherein each step is conducted by one or more special purpose computer servers designed to serve as a storage server for storing data records in accordance with a logical data model, which method comprises:
collecting various, diverse agricultural, administrative and environmental data from personal computers, mobile phones, farm machines and third party computer servers, wherein the collecting of data includes:
assigning the Farm Plot Number to the agriculture product first planted or managed at an origin site;
compiling daily farming activities for the agriculture product, and associating the compiled activities to the agriculture product via the Farm Plot Number;
compiling harvest activities related to the harvesting of the agriculture product at the origin site, and associating the compiled activities to the agriculture product via the Farm Plot Number;
compiling post-harvest activities for the agriculture product, and associating the compiled activities to the agriculture product via the Farm Plot Number;
compiling additional records and modified existing records as to daily farming activities, harvest activities and post-harvest activities for the agriculture product, and associating the compiled records to the agriculture product via the Farm Plot Number;
maintaining all data association with the Farm Plot No. without changing or modifying the Farm Plot Number during the entire term of the agricultural production cycle;
providing processed tracking information in a generated report summarizing the compiled data to authenticate all activities related to the agriculture product's origin, production and distribution, wherein the server generated report is produced upon receiving a single user input of the Farm Plot Number by which all data associated with that user input is included for compilation and is then presented on a graphical user interface or outputted in a printed form;
wherein the compiled data improves the functioning and performance of the computer servers by reducing to a minimum the number of times necessary to access and retrieve all of the compiled data use by querying the computer servers with the Farm Plot Number.

11. The computer-based method of claim 10, wherein:
(a) the compiled agricultural data comprises combinations of the following related to the agriculture product:
data records that document farming activities relating to preparing the land or livestock for the agriculture product's growth;
data records that document farming activities related to attending to the agriculture product through the agriculture product's growth from its origin up to harvesting;
data records that document crop, animal, or fish product varieties differentiated by type, family and bioengineering, which are variations selected and used for production;
data records that document water consumption by the agriculture product; and
data records that document the quality of the agriculture product from monitoring the agriculture product throughout growth;
(b) the compiled administrative data comprises combinations of the following related to the agriculture product:
equipment asset data records that document usage;
vendor data records differentiated by vendor contributions during production;
accounting data records that document purchase and sales orders;
employee data records; and
geographical location data records; and
(c) the compiled environmental data comprises combinations of the following related to the agriculture product:
water sampling data records that evaluate water quality;
soil sampling data records that evaluate soil quality;
plant monitoring data records that document status, growth and health of cultivated plants;
pest data records that document risks to plant cultivation; and
weather monitoring data records that document temperature, barometric pressure, precipitation and related weather data.

12. The computer-based method of claim 10, which further comprises compiling process data in the database to authenticate all activities related to processing, packaging, and shipping the agriculture product; wherein the compiled process data comprises combinations of the following related to the agriculture product:
data records that document preparing the agriculture product for packaging once it arrives at a packing facility and packaging the agriculture product for shipment to market, or alternatively, data records that document converting the agriculture product into a new product and then packaging the converted agriculture product for shipment to market; and
data records that document shipping information including the agriculture product's point of origin, final destination for sale, estimated time of departure and arrival, and transportation identification including shipping container or shipping pallet identification.

13. The computer-based method of claim 10, which further comprises:
assigning the Farm Plot Number to the agriculture product;
compiling daily farming activities for the agriculture product, and associating the compiled activities to the agriculture product via the Farm Plot Number;
processing the agriculture product for shipment;
compiling processing activities related to the processing of the agriculture product, and associating the compiled activities to the agriculture product via the Farm Plot Number;
shipping the agriculture product;
compiling shipping information of the agriculture product, and associating the shipping information to the agriculture product via the Farm Plot Number; and
providing a listing of the compiled information on the shipped agriculture product to confirm for consumers the creation, processing and tracking of the agriculture product from its origin to final point of sale, wherein the server generated listing is produced upon receiving a single user input of the Farm Plot Number by which all data associated with that user input is included for compilation.

14. (canceled)

15. A non-transitory processor readable medium for carrying out the computer-based method of claim 10 comprising processor readable instructions that when executed by the computer processor cause the computer processor to perform the method.

16.-20. (canceled)

21. The computer-based method of claim 10, which further comprises assigning the Farm Plot Number to the agriculture product at an origin site to assist in compiling the data regarding the agriculture product as it is produced from the origin site, and then is subsequently processed, packaged and made available for distribution at a final destination for sale to consumers.

22. A non-transitory processor readable medium for carrying out the computer-based method of claim 21 comprising processor readable instructions that when executed by the computer processor cause the computer processor to perform the method.

23. The computer-based method of claim 10, wherein the logical data model divides the data associated with the agriculture product's origin, production and distribution into a plurality of data tables and organizes the data tables with one or more data relationships between the data tables in a single database, the logical data model further comprising the following data relationships:
farm or supplier data table identifying agricultural producers differentiated by type, and associating one farm or supplier record with one or more farm plot records;
farm or supplier data table further identifying processing factories differentiated by type, and associating one farm or supplier record with one or more processing batch records;
farm plot data table identifying divided farm plot records associated with agriculture product variety records first planted or managed on the farm plots, and associating one farm plot record with one agriculture product variety record;
crop variety data table identifying agriculture product varieties differentiated by type, family, species and bioengineering, and associating one agriculture product variety record with one or more farm plot records;
crop protection data table identifying farming activities related to chemical applications differentiated by chemical stock supply type, and associating one farm plot record with one or more chemical application records;
protective equipment data table identifying employee work safety compliance related to chemical applications, and associating one chemical application record with one or more protective equipment records;
water usage data table identifying farming activities related to irrigation and watering differentiated by equipment type that is used to draw water from a water source, and associating one farm plot record with one or more water usage records;
crop harvest data table identifying farming activities related to harvesting differentiated by equipment type that is used to haul the raw agriculture product from the field, and associating one farm plot record with one or more crop harvest records;
food processing data table identifying processing batch records associated with agriculture product variety records that are prepared for conversion into a new product;
received food data table identifying post-harvest activities related to receiving crop harvests differentiated by equipment type that is used to haul the harvest from the field, and associating one farm plot record with one or more received for packing records;
received food data table further identifying post-harvest activities related to receiving crop harvests for conversion into a new product and differentiated by equipment type that is used to haul the harvest from the field, and associating one processing batch record with one or more received for packing records;
received food data table further identifying crop harvests first planted or managed on an associated farm plot and second processed in an associated processing batch;
sampled item data table identifying post-harvest activities related to capturing characteristics of the crop harvests for quality control, and associating one received for packing record with one or more sampled agriculture product records;
packing boxed food data table identifying post-harvest activities related to packing unprocessed crop harvests into individual packages, and associating one farm plot record with one or more package records;
packing boxed food data table further identifying post-harvest activities related to packing processed crop harvests that had been converted into a new product into individual packages, and associating one processing batch record with one or more package records;
packing boxed food data table further identifying packaged records first planted or managed on an associated farm plot and second processed in an associated processing batch;
shipping pallet data table identifying shipment activities related to bundling packaged agriculture products in preparation for transportation, and associating one shipping pallet record with one or more packaged records; and
shipping container data table identifying shipment activities related to transportation of bundled packages on pallets, and associating one shipping container record with one or more pallet records; and
wherein the shipping container, shipping pallet and packing boxed food data tables, together identify agriculture products originating from farm plots, and associate one farm plot record with one or more shipping container records.

24. The computer-based method of claim 10, wherein the logical data model divides the data associated with the agriculture product's precise location as it moves from origin through distribution in a plurality of data tables and organizes the data tables with one or more data relationships between the data tables in a single database, the logical data model further comprising the following data relationships:
a GPS coordinates data table identifying the fixed perimeter of farm or supplier facilities, and associating one farm or supplier facility record with one or more GPS coordinate records all of which provide an increasingly accurate shape of the facility's perimeter;
a GPS coordinates data table identifying the fixed perimeter of farm plots associated with agriculture product varieties, and associating one farm plot record with one or more GPS coordinate records all of which provide an increasingly accurate shape of the farm plot's perimeter;
a GPS coordinates data table identifying the tracked movement of packaged agriculture products being transported from one facility to the next facility, and associating one packaged product record with one or more GPS coordinate records any coordinate point of which indicates a recorded location along the product's travel path; and
a GPS coordinates data table identifying the tracked movement of freight shipments across road, rail or sea from terminal or port origin to terminal or port destination, and associating one freight shipment record with one or more GPS coordinate records any coordinate point of which indicates a recorded location along the shipment's travel path.

25. The computer-based method of claim 10, wherein the logical data model dividing the data associated with the agriculture product's administrative management and environment monitoring in a plurality of data tables and organizing the data tables with one or more data relationships between the data tables in a single database, the logical data model further comprising the following data relationships:
one or more data tables related to inventory management identifying purchased and used equipment and supplies and wherein one equipment or supply record is associated with one or more activity records related to origin, production or distribution;
one or more data tables related to vendor management identifying organizations differentiated by type that provide or receive goods or services and wherein one vendor record is associated with one or more activity records related to origin, production or distribution;
one or more data tables related to financial management identifying purchase and sales orders and wherein one purchase order record is associated with one or more purchased equipment or supply records and one sales order record is associated with one or more sold agriculture product records;
one or more data tables related to human resources identifying persons employed or contracted to perform work and wherein one person record is associated with one or more activity records related to origin, production or distribution;
one or more data tables related to geographical location identifying jurisdictions and wherein one jurisdiction record is associated with one or more activity records related to origin, production or distribution;
one or more data tables related to water sampling identifying the quality of local water sources and wherein one or more water sampling records are associated with one water source record;
one or more data tables related to soil sampling identifying the quality of local soil conditions and wherein one or more soil sampling records are associated with one farm plot record;
one or more data tables related to plant monitoring identifying the quality of cultivated plants and wherein one or more plant monitoring records are associated with one farm plot record;
one or more data tables related to pest management identifying the local occurrences of pests and wherein one or more pest occurrence records are associated with one farm plot record; and
one or more data tables related to weather monitoring identifying local weather conditions and wherein one or more weather monitoring records are associated with one farm plot record.
